(19) United States
(12) Patent Application Publication
(10) Pub. No.: US 2025/0036956 A1
(43) Pub. Date: Jan. 30, 2025

(54) TRAINING AND/OR OPERATING GRAPH NEURAL NETWORK BASED RECOMMENDATION SYSTEM

(71) Applicant: City University of Hong Kong, Kowloon (HK)

(72) Inventors: Sichun Luo, Kowloon (HK); Linqi Song, Kowloon (HK)

(21) Appl. No.: 18/358,314

(22) Filed: Jul. 25, 2023

(51) Int. Cl. G06N 3/091; G06F 16/901

(52) U.S. Cl. CPC G06N 3/091; G06F 16/9024

(57) ABSTRACT

A method for training a graph neural network based recommendation system. The method includes receiving and processing a dataset to generate graph representation data. The dataset includes user data associated with users, item data associated with items, and user-item interaction data associated with interactions between users and items. Some items have less user-item interactions than some other items. The graph representation data includes data associated with user nodes, data associated with item nodes, and data associated with user-item interaction edges. Some item nodes have less user-item interaction edges than some other item nodes. The method further includes processing the graph representation data to obtain modified graph representation data, which can facilitate learning or determining of representations of at least some of the item nodes with less user-item interactions. The method further includes training the graph neural network based recommendation system based at least partly on the modified graph representation data.

### TECHNICAL FIELD

The invention generally relates to training and/or operating a graph neural network based recommendation system.

### BACKGROUND

Machine learning based recommendation systems are information processing and filtering systems that use machine learning techniques to provide suggestions or recommendation of items to users. One problem associated with some existing machine learning based recommendation systems is that they may be susceptible to biases such as popularity bias. Reducing such biases may improve fairness and overall performance of machine learning based recommendation systems.

### SUMMARY OF THE INVENTION

In a first aspect, there is provided a computer-implemented method for training a graph neural network based recommendation system. The method comprises receiving a dataset. The dataset includes user data associated with users, item data associated with items, and user-item interaction data associated with user-item interactions (i.e., interactions between the users and the items), with some of the items having less user-item interactions than some other of the items. The method also comprises processing the dataset to generate graph representation data of the dataset. The graph representation data comprises data associated with nodes and data associated with edges connecting the nodes, the nodes comprising user nodes and item nodes, the edges comprising user-item interaction edges each being connected with an item node and a user node, with some of the item nodes having less user-item interaction edges than some other of the item nodes. The method further comprises processing the graph representation data of the dataset to modify (or augment) the graph representation data of the dataset to obtain modified graph representation data. The modified graph representation data can facilitate learning or determining of representations of at least some of the item nodes with less user-item interactions. The method further comprises training one or more graph neural network based recommender models of the graph neural network based recommendation system based at least in part on the modified graph representation data.

The user-item interactions may include feedback (e.g., ratings, scores, etc.) provided by the users on the items. Some users may provide feedback on more items; some users may provide feedback on less items.

The representations may correspond to embeddings, and their learning or determining may be performed by the one or more graph neural network based recommender models of the graph neural network based recommendation system.

In the dataset, distribution of the user-item interactions in respect of the items is imbalanced or skewed. In some embodiments, in the dataset, an amount of the user-item interactions in respect of the items generally follows a heavy-tail or long-tail distribution such that some of the items have much more user interactions than some other of the items.

In some embodiments, processing the graph representation data of the dataset comprises: performing an edge addition operation to add one or more edges to the graph representation data.

In some embodiments, performing the edge addition operation comprises: performing a homogenous edge addition operation to add, to the graph representation data, one or more item-item edges for at least some of the item nodes with less user-item interaction edges. Each of the one or more item-item edges is respectively connected with two item nodes, at least one of which is one of the item nodes with less user-item interaction edges.

In some embodiments, performing the homogenous edge addition operation comprises, for each of the at least some of the item nodes with less user-item interactions, respectively: determining, from the item nodes, one or more structural neighbor item nodes, and adding, to the graph representation data, one or more item-item edges each between the corresponding item node and one of its one or more structural neighbor item nodes.

In some embodiments, determining one or more structural neighbor item nodes comprises: determining an item similarity matrix based on the user-item interactions (the item similarity matrix comprises co-interaction values each for two respective items), and determining the one or more structural neighbor item nodes based on the co-interaction values in the item similarity matrix.

In some embodiments, performing the homogenous edge addition operation comprises, for each of the at least some of the item nodes with less user-item interactions, respectively: determining, from the item nodes, one or more sematic neighbor item nodes, and adding, to the graph representation data, one or more item-item edges each between the corresponding item node and one of its one or more sematic neighbor item nodes.

In some embodiments, determining one or more sematic neighbor item nodes comprises: clustering the items based on a clustering method to form a plurality of clusters of items; and the adding includes adding one or more item-item edges each between the corresponding item node and one of the items in the same cluster as the corresponding item node.

In some embodiments, the clustering is based on K-means method or mean-shift method.

In some embodiments, the performing the homogenous edge addition operation comprises: performing a message passing operation based at least in part on the graph representation data added with the one or more item-item edges each between the corresponding item node and one of its one or more structural neighbor item nodes and the one or more item-item edges each between the corresponding item node and one of its one or more sematic neighbor item nodes.

In some embodiments, processing the graph representation data of the dataset comprises or further comprises: performing an edge drop operation to drop one or more of the user-item interaction edges. In some embodiments in which edge addition operation and edge drop operation are both performed, the edge drop operation may be performed after the edge addition operation.

In some embodiments, performing the edge drop operation comprises: performing an adaptive heterogeneous edge drop operation to drop some of the user-item interaction edges in such a way that an amount of user-item interaction edges dropped in respect of the at least some of the item nodes with less user-item interactions is less than an amount of user-item interaction edges dropped in respect of item nodes with more user-item interactions.

In some embodiments, performing the adaptive heterogeneous edge drop operation comprises, for each of at least some of the item nodes, respectively: determining an extent of which an item node has insufficient user interactions, and dropping user-item interaction edges associated with the item node based on the determined extent such that more user-item interaction edges are dropped for item nodes with less insufficient user interactions and less user-item interaction edges are dropped for item nodes with more insufficient user interactions.

In some embodiments, processing the graph representation data of the dataset further comprises: performing a node synthesis operation to add at least one or more synthetic item nodes to the graph representation data. In some embodiments, the node synthesis operation also adds one or more corresponding synthetic user-item interaction edges to the graph representation data.

In some embodiments, performing the node synthesis operation comprises: processing the graph representation data of the dataset using the one or more graph neural network based recommender models of the graph neural network based recommendation system to determine embeddings associated with the user nodes and embeddings associated with the item nodes; performing a data mixup operation to generate one or more synthetic item nodes based at least in part on the embeddings associated with the user nodes and the embeddings associated with the item nodes; and for each of the one or more synthetic item nodes, generating a corresponding synthetic user-item interaction edge based at least in part on a hyper-parameter.

In some other embodiments, performing the node synthesis operation comprises: processing the graph representation data of the dataset using the one or more graph neural network based recommender models of the graph neural network based recommendation system to determine a set of data including user-item-interaction triplets and corresponding embeddings associated with the graph representation data; performing a first data augmentation operation on the set of data to generate a first synthesized dataset with one or more synthesized user-item-interaction triplets and one or more corresponding embeddings; processing the set of data and the first synthesized dataset using a bilateral branch network model to compare or determine performance of the item nodes; based on the comparison or determination, selecting item nodes for performing data augmentation; and performing a second data augmentation operation on the set of data for the selected item nodes to generate a second synthesized dataset including the one or more synthetic item nodes and the one or more corresponding synthetic user-item interaction edges. In some embodiments, the training comprises training the one or more graph neural network based recommender models of the graph neural network based recommendation system using a combination of the dataset and the second synthesized dataset.

In some embodiments, the bilateral branch network model comprises two generally identical branches each including one or more graph neural network based recommender models. In some embodiments, the processing of the set of data and the first synthesized dataset comprises: processing the set of data using one of the branches of the bilateral branch network model, and processing a combination of the set of data and the first synthesized dataset using another one of the branches of the bilateral branch network model.

In some embodiments, the first data augmentation operation comprises a data mixup operation and/or a data resampling operation. In some embodiments, the data mixup operation comprises mixing one or more pairs of user-item-interaction triplets and their corresponding embeddings to generate synthesized data. In some embodiments, the data resampling operation comprises selectively drawing and dropping out at least some of the user-item-interaction triplets and corresponding embeddings from the set of data.

In some embodiments, the second data augmentation operation comprises a data mixup operation and/or a data resampling operation. In some embodiments, the data mixup operation comprises mixing one or more pairs of user-item-interaction triplets and their corresponding embeddings to generate synthesized data. In some embodiments, the data resampling operation comprises selectively drawing and dropping out at least some of the user-item-interaction triplets and corresponding embeddings from the set of data.

In some embodiments, the training comprises training the one or more graph neural network based recommender models of the graph neural network based recommendation system using graph contrastive learning technique. In some embodiments, the graph contrastive learning technique comprises augmentation based contrastive learning technique, which includes graph representation data modification and noise injection. In some embodiments, the training comprises optimizing a loss function that takes into account recommendation loss, regularization loss, and contrastive loss.

In some embodiments, the training comprises: in a first training stage, training the one or more graph neural network based recommender models of the graph neural network based recommendation system using the graph representation data, and in a second training stage, training the one or more one or more graph neural network based recommender models of the graph neural network based recommendation system using the modified graph representation data. In some embodiments, the training comprises optimizing a loss function that takes into account, at least, recommendation loss and regularization loss.

In a second aspect, there is provided a system for training a graph neural network based recommendation system, comprising: one or more processors, and memory storing one or more programs configured to be executed by the one or more processors, the one or more programs including instructions for performing or facilitating performing of the computer-implemented method of the first aspect.

In a third aspect, there is provided a non-transitory computer readable storage medium storing one or more programs configured to be executed by one or more processors, the one or more programs including instructions for performing or facilitating performing of the computer-implemented method of the first aspect.

In a fourth aspect, there is provided a computer-implemented method for operating a graph neural network based recommendation system, comprising: processing user data and item data, using the one or more graph neural network based recommender models of the graph neural network based recommendation system trained using the computer-implemented method of claim 1, to determine an item recommendation for a user. In some embodiments, the computer-implemented method further comprises presenting (e.g., displaying) the item recommendation. The item recommendation may include one or more items recommended to the user.

In a fifth aspect, there is provided a system for operating a neural network based ranking model, comprising: one or more processors, and memory storing one or more programs configured to be executed by the one or more processors, the one or more programs including instructions for performing or facilitating performing of the computer-implemented method of the fourth aspect. In some embodiments, the system also includes a display.

In a sixth aspect, there is provided a non-transitory computer readable storage medium storing one or more programs configured to be executed by one or more processors, the one or more programs including instructions for performing or facilitating performing of the computer-implemented method of the fourth aspect.

Other features and aspects of the invention will become apparent by consideration of the detailed description and accompanying drawings. Any feature(s) described herein in relation to one aspect or embodiment may be combined with any other feature(s) described herein in relation to any other aspect or embodiment as appropriate and applicable.

Terms of degree such that “generally”, “about”, “substantially”, or the like, are used, depending on context, to account for manufacture tolerance, degradation, trend, tendency, imperfect practical condition(s), etc. For example, “generally increasing” refers to a general tendency of increasing (not necessarily strictly or monotonically increasing). For example, “generally decreasing” refers to a general tendency of decreasing (not necessarily strictly or monotonically decreasing).

As used herein, unless otherwise specified, the term “item” is used generally to refer to item of information such as digital image, photograph, electronic document or file, web page, part of a web page, map, electronic link, commercial product, non-commercial product, multimedia file, song, book, album, article, database record, human, object etc.

### BRIEF DESCRIPTION OF THE DRAWINGS

Embodiments of the invention will now be described, by way of example, with reference to the accompanying drawings in which:

FIG. 1A is a schematic diagram illustrating a graph representation of a dataset in one example;

FIG. 1B is a schematic diagram illustrating a graph representation of a dataset in one example;

FIG. 2 is a schematic diagram illustrating a graph neural network based recommendation system training framework in some embodiments of the invention;

FIG. 3 is a flowchart illustrating a method for training a graph neural network based recommendation system in some embodiments of the invention;

FIG. 4 is a flowchart illustrating a method for modifying graph representation data in some embodiments of the invention;

FIG. 5 is a flowchart illustrating a method for modifying graph representation data in some embodiments of the invention;

FIG. 6 is a flowchart illustrating a method for modifying graph representation data in some embodiments of the invention;

FIG. 7 is a flowchart illustrating a method for modifying graph representation data in some embodiments of the invention;

FIG. 8 is a flowchart illustrating a method for modifying graph representation data in some embodiments of the invention;

FIG. 9A is a flowchart illustrating a method for modifying graph representation data in some embodiments of the invention;

FIG. 9B is a flowchart illustrating a method for modifying graph representation data in some embodiments of the invention;

FIG. 10A is a flowchart illustrating a method for training a graph neural network based recommendation system in some embodiments of the invention;

FIG. 10B is a schematic diagram illustrating a method for training a graph neural network based recommendation system in some embodiments of the invention;

FIG. 11 is a schematic diagram illustrating a graph contrastive learning based framework with adaptive augmentation for long-tail recommendation (GALR) in some embodiments of the invention;

FIG. 12 is a schematic diagram illustrating a message passing operation in GALR in some embodiments of the invention;

FIG. 13 is a schematic diagram illustrating a training data augmentation operation in GALR in some embodiments of the invention;

FIG. 14 is a table listing details of the four datasets (ML-1M, Douban-Book, Yelp2018, and Amazon-Book) used in some example experiments;

FIG. 15A is a table listing recommendation performance of the GALR embodiment and other existing methods on two datasets (ML-1M and Douban-Book) in some example experiments;

FIG. 15B is a table listing recommendation performance of the GALR embodiment and other existing methods on two other datasets (Yelp2018 and Amazon-Book) in some example experiments;

FIG. 16 is a table listing recommendation performance of the GALR embodiment on the ML-1M dataset in some example ablation study experiments;

FIG. 17 is a table listing performance of the GALR embodiment on the ML-1M dataset for different edge drop rates in some example experiments;

FIG. 18 is a table listing performance of the GALR embodiment on the ML-1M dataset for different cluster numbers in some example experiments;

FIG. 19 is a table listing performance of the GALR embodiment on the ML-1M dataset for different structural neighbor numbers in some example experiments;

FIG. 20A is a graph showing recommendation performance for all items on the ML-1M dataset with respect to different embedding dimensions in some example experiments;

FIG. 20B is a graph showing recommendation performance for the head items on the ML-1M dataset with respect to different embedding dimensions in some example experiments;

FIG. 20C is a graph showing recommendation performance for the tail items on the ML-1M dataset with respect to different embedding dimensions in some example experiments;

FIG. 21A is a graph showing two dimensional (2D) visualization of tail and head items embeddings obtained by LightGCN on the ML-1M dataset in one example experiment;

FIG. 21B is a graph showing two dimensional (2D) visualization of tail and head items embeddings obtained by the GALR embodiment on the ML-1M dataset in one example experiment;

FIG. 22 is a schematic diagram illustrating a graph augmentation based framework for long-tail recommendation (GALORE) in some embodiments of the invention;

FIG. 23 is a schematic diagram illustrating a message passing operation in GALORE in some embodiments of the invention;

FIG. 24 is a table listing details of the four datasets (ML-1M, Douban-Book, Yelp2018, and Gowalla) used in some example experiments;

FIG. 25A is a graph illustrating a cumulative distribution Function (CDF) of item distribution in the ML-1M dataset used in some example experiments;

FIG. 25B is a graph illustrating a cumulative distribution Function (CDF) of item distribution in the Douban-Book dataset used in some example experiments;

FIG. 25C is a graph illustrating a cumulative distribution Function (CDF) of item distribution in the Yelp2018 dataset used in some example experiments;

FIG. 25D is a graph illustrating a cumulative distribution Function (CDF) of item distribution in the Gowalla dataset used in some example experiments;

FIG. 26A is a table listing recommendation performance of the GALORE embodiment and other existing methods on two datasets (ML-1M and Douban-Book) in some example experiments;

FIG. 26B is a table listing recommendation performance of the GALORE embodiment and other existing methods on two datasets (ML-1M and Gowalla) in some example experiments;

FIG. 27 is a table listing recommendation performance of the GALORE embodiment on the Douban-Book dataset in some example ablation study experiments;

FIG. 28 is a table listing performance of the GALORE embodiment on the Douban-Book dataset for different edge drop rates in some example experiments;

FIG. 29A is a graph showing recommendation performance (metrics: Recall and Normalized Discounted Cumulative Gain (NDCG)) of the GALORE embodiment with respect to different synthetic node rates for all items (head and tail items) in one example experiment;

FIG. 29B is a graph showing recommendation performance (metrics: Recall and Normalized Discounted Cumulative Gain (NDCG)) of the GALORE embodiment with respect to different synthetic node rates for head items in one example experiment;

FIG. 29C is a graph showing recommendation performance (metrics: Recall and Normalized Discounted Cumulative Gain (NDCG)) of the GALORE embodiment with respect to different synthetic node rates for tail items in one example experiment;

FIG. 30A is a graph showing recommendation performance (metrics: Recall and Normalized Discounted Cumulative Gain (NDCG)) of the GALORE embodiment with respect to different embedding dimensions for all items (head and tail items) in one example experiment;

FIG. 30B is a graph showing recommendation performance (metrics: Recall and Normalized Discounted Cumulative Gain (NDCG)) of the GALORE embodiment with respect to different embedding dimensions for head items in one example experiment;

FIG. 30C is a graph showing recommendation performance (metrics: Recall and Normalized Discounted Cumulative Gain (NDCG)) of the GALORE embodiment with respect to different embedding dimensions for tail items in one example experiment; and

FIG. 31 is a schematic diagram of an example data processing system that can be used to perform one or more of the methods in embodiments of the invention.

### DETAILED DESCRIPTION

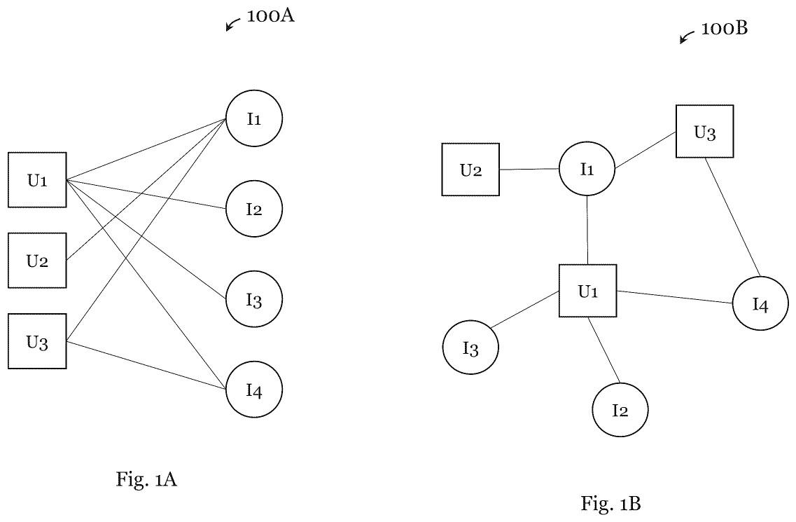

FIG. 1A shows a graph representation 100A of a recommendation-related dataset in one example. The recommendation-related dataset includes user data associated with three users, item data associated with four items, and user-item interaction data associated with interactions between the users and the items, such as feedback (e.g., ratings, scores, etc.) provided by the users on the items. In this example, the amount of feedback provided by different users are different. The graph representation represents the recommendation-related dataset using nodes and edges (lines connecting two nodes). Specifically, the graph representation includes three user nodes U1, U2, U3 representing the users, four item nodes I1, I2, I3, I4 representing the items, and multiple user-item interaction edges connecting the user nodes U1, U2, U3 and the item nodes I1, I2, I3, I4 and representing the interactions between the users and the items. In this example, the user represented by user node U1 has interacted with all four items represented by item nodes I1, I2, I3, I4 so there exists an edge between the user node U1 and the item node I1, an edge between the user node U1 and the item node I2, an edge between the user node U1 and the item node I3, and an edge between the user node U1 and the item node I4. In this example, the user represented by user node U2 has interacted with only one item represented by item node I1 so there exists an edge between the user node U2 and the item node I1. In this example, the user represented by user node U3 has interacted with two items represented by item nodes I1, I4 so there exists an edge between the user node U3 and the item node I1 and an edge between the user node U3 and the item node I4. While not illustrated, attributes or information associated with the users may be embedded in the user nodes U1, U2, U3; attributes or information associated with the items may be embedded in the item nodes I1, I2, I3, I4; and attributes or information associated with the user-item interaction may be embedded in the user-item interaction edges. The graph representation 100A may be used as or to form a graph, such as an input graph, for processing by a graph neural network base recommendation system.

FIG. 1B shows a graph representation 100B of a recommendation-related dataset in one example. In this example, the recommendation-related dataset is the same as the one in FIG. 1A, i.e., the graph representation 100B is another way of representing the same recommendation-related dataset.

It should be appreciated that the graph representations 100A, 100B are merely examples. In other examples, the recommendation-related datasets may have different number of users than illustrated (not limited to three), different number of items than illustrated (not limited to four), and/or different number of user-item interactions than illustrated hence different graph representations than illustrated.

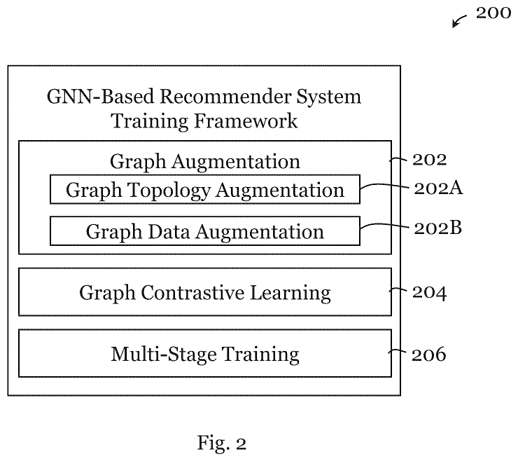

FIG. 2 shows a graph neural network (GNN) based recommendation system training framework 200 in some embodiments of the invention. The framework 200 applies various computer-implemented processing and/or training strategies to improve the performance of the graph neural network based recommendation system. The strategies include, e.g., graph augmentation 202 (which may include graph topology argumentation 202A and/or graph data augmentation 202B), graph contrastive learning 204, multi-stage training 206, etc. These strategies may be useful to deal with, among other things, insufficient or imbalance of available training data (e.g., long-tail or heavy-tail data) or popularity bias, to improve fairness or overall performance of the graph neural network based recommendation system. In some examples, all of these strategies are applied to synergistically improve fairness or overall performance of the graph neural network based recommendation system. In some other examples, only one or some (not all) of these strategies are applied to improve fairness or overall performance of the graph neural network based recommendation system.

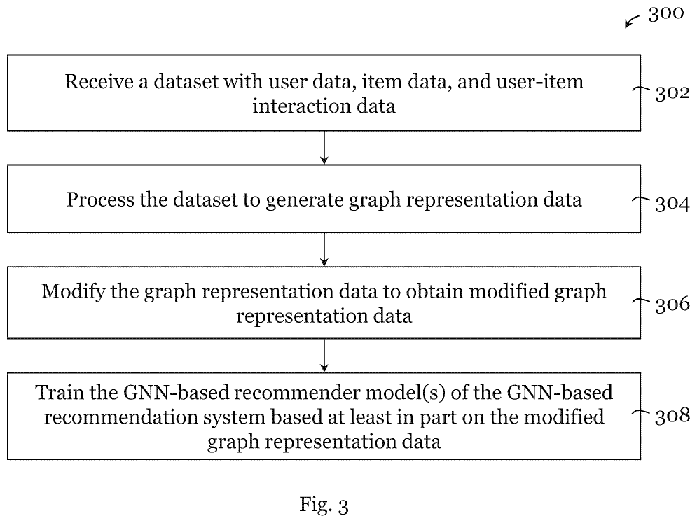

FIG. 3 shows a general method 300 for training a graph neural network based recommendation system in some embodiments of the invention. The method 300 is a computer-implemented method.

The method 300 includes, in step 302, receiving a dataset, in particular a recommendation-related dataset with user data, item data, and user-item interaction data, such as that described with reference to FIG. 1A. The user data includes data associated with users. The item data includes data associated with items. The user-item interaction data includes data associated with user-item interactions (i.e., interactions between the users and the items). The user-item interactions may be feedback (e.g., ratings, scores, etc.) provided by the users on the items. In some examples, some users may provide feedback on more items whereas some users may provide feedback on less items. In other words, some of the items may have less user-item interactions (or user interactions) than some other of the items. As a result, the distribution of the user-item interactions in respect of the items may be imbalanced or skewed. In some examples, an amount of the user-item interactions in respect of the items generally follows a heavy-tail or long-tail distribution such that some of the items have much more user interactions (e.g., more feedback from more users) than some other of the items.

The method 300 also includes, in step 304, processing the dataset to generate graph presentation data of the dataset. The graph representation data includes data associated with nodes and data associated with edges connecting the nodes. Specifically, the nodes include user nodes and item nodes whereas the edges include user-item interaction edges each being connected with an item node and a user node. The user nodes may represent the users in the dataset. The item nodes may represent the items in the dataset. The user-item interaction edges may represent the user-item interactions in the dataset. In some examples, as the distribution of the user-item interactions in respect of the items may be imbalanced or skewed, some of the item nodes may have less user-item interaction edges than some other of the item nodes.

The method 300 also includes, in step 306, modifying the graph representation data of the dataset to obtain modified graph representation data of the dataset. The modification of the graph representation data of the dataset may help to improve representation of the dataset. In some embodiments, the modification of the graph representation data of the dataset may facilitate learning or determining of representations or embeddings associated with the nodes, e.g., at least some of the item nodes with less user-item interactions. In some examples, the learning or determining of representations or embeddings associated with at least some of the item nodes with less user-item interactions may be performed by one or more graph neural network based recommender models of the graph neural network based recommendation system.

The method 300 also includes, in step 308, training one or more graph neural network based recommender models of the graph neural network based recommendation system based at least in part on the modified graph representation data. In some embodiments, the training is further based on at least part of the graph representation data.

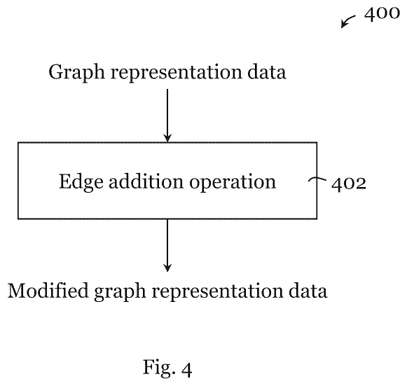

FIG. 4 shows a method 400 for modifying graph representation data in some embodiments of the invention. In some embodiments, the method 400 can be considered as belonging to the graph topology augmentation operation 202A in FIG. 2 or step 306 in the method 300 of FIG. 3. The method 400 includes, in step 402, processing the graph representation data, such as that obtained in step 304 in the method 300 of FIG. 3, by performing an edge addition operation to add one or more edges to the graph representation data, to form modified graph representation data. In some embodiments, the edge addition operation includes a homogenous edge addition operation to add one or more item-item edges (each respectively connects two item nodes), e.g., for at least some of the item nodes with less user-item interaction edges. In some examples, each item-item edge is respectively connected with two item nodes, at least one of which may be an item node with less user-item interaction edges. In some embodiments, the edge addition operation is a homogenous edge addition operation to add one or more user-user edges (each respectively connects two user nodes), e.g., for at least some of the user nodes with less user-item interaction edges. In some examples, each user-user edge is respectively connected with two user nodes, at least one of which may be a user node with less user-item interaction edges. In some embodiments, the performing the homogenous edge addition operation includes: performing a message passing operation based at least in part on the graph representation data added with the one or more item-item edges. In some embodiments, the performing the homogenous edge addition operation includes: performing a message passing operation based at least in part on the graph representation data added with the one or more user-user edges.

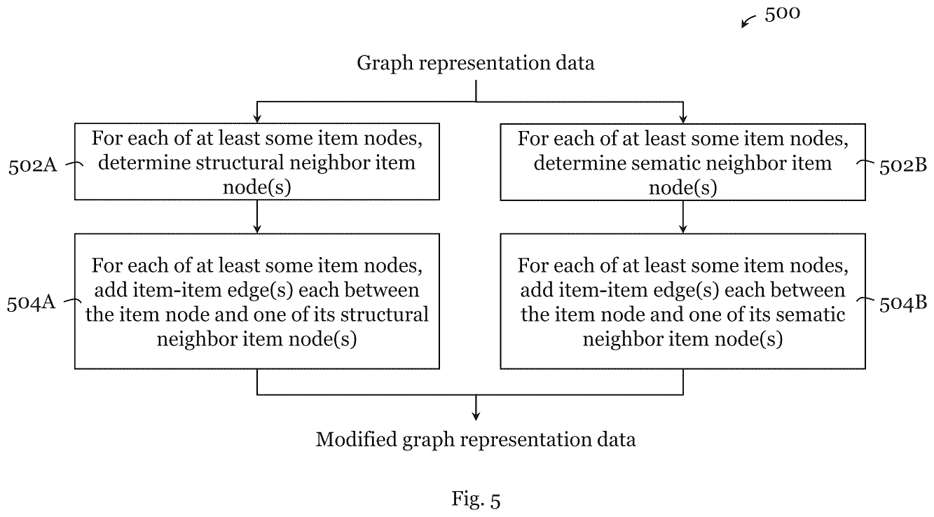

FIG. 5 shows a method 500 for modifying graph representation data in some embodiments of the invention. In some embodiments, the method 400 can be considered as belonging to step 402 in the method 400 of FIG. 4.

The method 500 includes, in step 502A, determining, for each of at least some item nodes (e.g., at least some item nodes with less user-item interactions), respective structural neighbor item node(s). The method 500 also includes, in step 504A, adding, for each of at least some item nodes (e.g., at least some item nodes with less user-item interactions), respective item-item edge(s) each between the item node and one of its structural neighbor item node(s). In some examples, the determination of the structural neighbor item node(s) includes: determining, based on the user-item interactions, an item similarity matrix that includes co-interaction values each for two respective items, and determining the structural neighbor item node(s) based on the co-interaction values in the item similarity matrix.

The method 500 includes, in step 502B, determining, for each of at least some item nodes (e.g., at least some item nodes with less user-item interactions), respective semantic neighbor item node(s). The method 500 also includes, in step 504B, adding, for each of at least some item nodes (e.g., at least some item nodes with less user-item interactions), respective item-item edge(s) each between the item node and one of its semantic neighbor item node(s). In some examples, the determination of the semantic neighbor item node(s) may include: clustering the items based on a clustering method (e.g., K-means method, mean-shift method, etc.) to form clusters of items. The adding in step 504B may include adding item-item edge(s) each between the corresponding item node and one of the items in the same cluster as the corresponding item node.

In some embodiments, method 400 further includes: performing a message passing operation based at least in part on the graph representation data added with the item-item edge(s) each between the item node and one of its structural neighbor item node(s) and the item-item edge(s) each between the item node and one of its semantic neighbor item node(s).

In some embodiments of method 500, steps 502A, 504A and steps 502B, 504B are all performed. In some embodiments of method 500, steps 502A, 504A are performed and steps 502B, 504B are not performed. In some embodiments of method 500, steps 502A, 504A are not performed and steps 502B, 504B are performed. The modified graph representation data obtained from the method 500 may be used for facilitating training of one or more graph neural network based recommender models of the graph neural network based recommendation system.

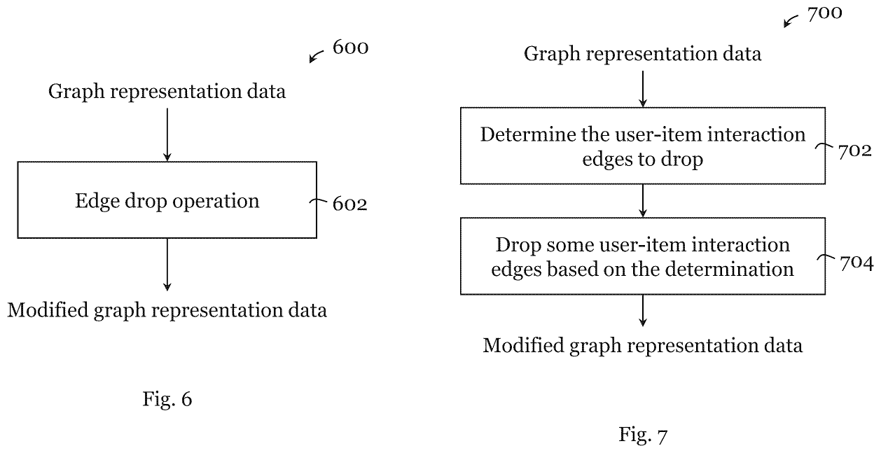

FIG. 6 shows a method 600 for modifying graph representation data in some embodiments of the invention. In some embodiments, the method 600 can be considered as belonging to the graph topology augmentation operation 202A in FIG. 2 or step 306 in the method 300 of FIG. 3. The method 600 includes, in step 602, processing the graph representation data, such as that obtained in step 304 in the method 300 of FIG. 3 or that obtained after an edge addition operation (such as the edge addition operations in FIGS. 4 and 5), by performing an edge drop operation to drop or remove some user-item interaction edges from the graph representation data, to form modified graph representation data. In some embodiments, the edge drop operation is an adaptive heterogeneous edge drop operation to drop some of the user-item interaction edges in such a way that an amount of user-item interaction edges dropped in respect of at least some item nodes with less user-item interactions is less than an amount of user-item interaction edges dropped in respect of item nodes with more user-item interactions. Edges for nodes with more abundant user-item interaction edges will more likely be dropped.

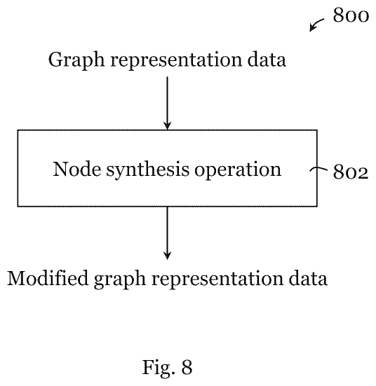

FIG. 7 shows a method 700 for modifying graph representation data in some embodiments of the invention. In some embodiments, the method 700 can be considered as belonging to step 602 in the method 600 of FIG. 6.

The method 700 includes, in step 702, determining, for each of at least some item nodes, the user-item interaction edges to drop. In some embodiments, this determination may include determining an extent of which each respective item node has insufficient user interactions. The extent may be directly or indirectly correlated with (not necessarily equal to) the number of user-item interaction edges associated with the item nodes. An item node connected with more user-item interaction edges is considered to have more sufficient user interactions than an item node connected with less user-item interaction edges.

The method 700 includes, in step 704, dropping some of the user-item interaction edges based on the determination in step 702. In some embodiments, for each of at least some of the item nodes, the dropping is based on the determined extent of which the item node has insufficient user interactions. Item node determined to have more sufficient user-item interaction edges will have more edges dropped compared to item node determined to have less sufficient user-item interaction edges. In some embodiments, the user-item interaction edges of one or more of the item nodes which has insufficient user interactions are not dropped (i.e., all persevered).

The modified graph representation data obtained from the method 700 may be used for facilitating training of one or more graph neural network based recommender models of the graph neural network based recommendation system.

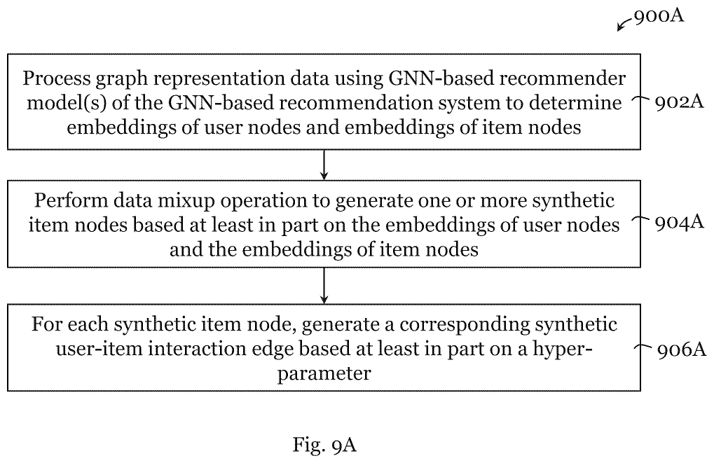

FIG. 8 shows a method 800 for modifying graph representation data in some embodiments of the invention. In some embodiments, the method 800 can be considered as belonging to the graph data augmentation operation 202B in FIG. 2 or step 306 in the method 300 of FIG. 3. The method 800 includes, in step 802, processing the graph representation data, such as that obtained in step 304 in the method 300 of FIG. 3 or that obtained after an edge addition operation (such as the edge addition operations in FIGS. 4 and 5) or that obtained after an edge drop operation (such as the edge drop operations in FIGS. 6 and 7), by performing a node synthesis operation to add at least one or more synthetic item nodes and preferably one or more corresponding synthetic user-item interaction edges to the graph representation data, to form modified graph representation data.

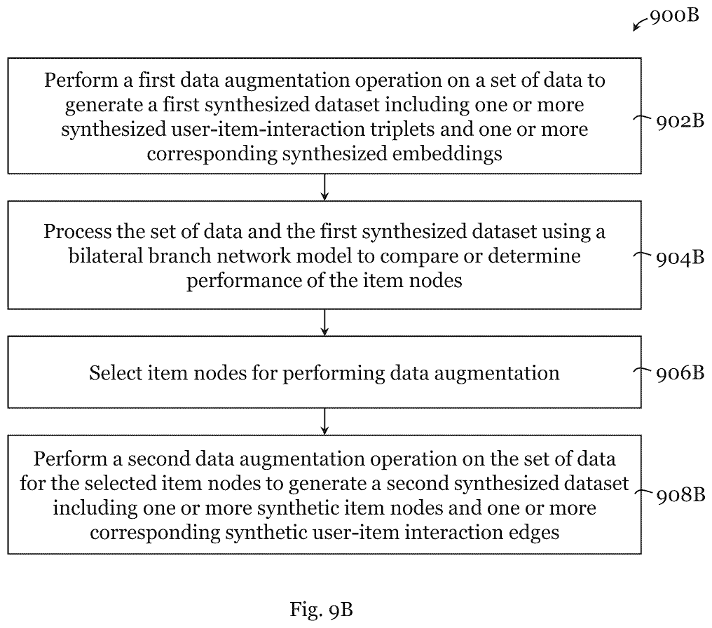

FIG. 9A shows a method 900A for modifying graph representation data in some embodiments of the invention. In some embodiments, the method 900A can be considered as belonging to step 802 in the method 800 of FIG. 8.

The method 900A includes, in step 902A, processing graph representation data, such as that obtained in step 304 in the method 300 of FIG. 3, using one or more graph neural network based recommender models of the graph neural network based recommendation system to determine embeddings of user nodes and embeddings of item nodes.

The method 900A includes, in step 904A, performing a data mixup operation to generate one or more synthetic item nodes based at least in part on the embeddings of user nodes and the embeddings of item nodes. In some embodiments, the data mixup operation includes, for generating each synthetic item node: selecting two item nodes from the item nodes, and generating the synthetic item node based on the embeddings of the two item nodes. In some embodiments, the selection of the two item nodes may be random.

The method 900A includes, in step 906A, for each of synthetic item node, generate a corresponding synthetic user-item interaction edge based at least in part on a hyper-parameter. In some embodiments, depending on the hyper-parameter, the synthetic item node either inherits the user node connection(s) of one of the corresponding two item nodes or the user node connection(s) of another one of the corresponding two item nodes.

The modified graph representation data obtained from the method 900A may be used for facilitating training of one or more graph neural network based recommender models of the graph neural network based recommendation system.

FIG. 9B shows another method 900B for modifying graph representation data in some embodiments of the invention. In some embodiments, the method 900B can be considered as belonging to step 802 in the method 800 of FIG. 8.

The method 900B includes, in step 902B, performing a first data augmentation operation on a set of data to generate a first synthesized dataset including one or more synthesized user-item-interaction triplets and one or more corresponding synthesized embeddings. The set of data on which the first data augmentation operation is performed may be obtained by processing graph representation data, such as that obtained in step 304 in the method 300 of FIG. 3, using one or more graph neural network based recommender models of the graph neural network based recommendation system. The first data augmentation operation may include a data mixup operation and/or a data resampling operation. For example, the data mixup operation may include mixing one or more pairs of user-item-interaction triplets and their corresponding embeddings to generate synthesized data. For example, the data resampling operation may include selectively drawing and dropping out at least some of the user-item-interaction triplets and corresponding embeddings from the set of data.

The method 900B includes, in step 904B, processing the set of data and the first synthesized dataset using a bilateral branch network model to compare or determine performance of the item nodes. In some embodiments, the bilateral branch network model includes two generally identical branches each including one or more graph neural network based recommender models, which may be, or may be generally identical to, the one or more graph neural network based recommender models of the graph neural network based recommendation system. In some embodiments, step 904B includes: processing the set of data using one of the branches of the bilateral branch network model and processing a combination of the set of data and the first synthesized dataset using another one of the branches of the bilateral branch network model. The comparing or determining of the performance of the item nodes can help to identify item nodes that could achieve performance improvement based on the first data augmentation operation. In some embodiments, the comparing or determining of the performance of the item nodes can help to identify item nodes that could achieve performance improvement over a certain threshold performance based on the first data augmentation operation.

The method 900B includes, in step 906B, selecting item nodes for performing data augmentation based on the comparison or determination of performance of the item nodes in step 904B. In some embodiments, item nodes that are determined to be able to achieve performance improvement are selected to perform training data augmentation. In some embodiments, item nodes that are determined to be able to achieve performance improvement over a certain threshold are selected to perform training data augmentation. In some embodiments, item nodes that are determined to be more able to achieve performance improvement are more likely to be selected to perform training data augmentation.

The method 900B includes, in step 908B, performing a second data augmentation operation on the set of data for the selected item nodes to generate a second synthesized dataset, which includes one or more synthetic item nodes and one or more corresponding synthetic user-item interaction edges. The second data augmentation operation may include a data mixup operation and/or a data resampling operation. For example, the data mixup operation may include mixing one or more pairs of user-item-interaction triplets and their corresponding embeddings to generate synthesized data. For example, the data resampling operation may include selectively drawing and dropping out at least some of the user-item-interaction triplets and corresponding embeddings from the set of data.

The modified graph representation data obtained from the method 900B may be used for facilitating training of one or more graph neural network based recommender models of the graph neural network based recommendation system.

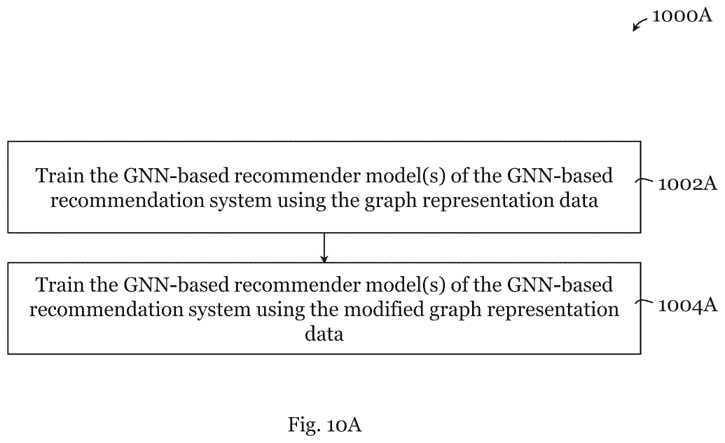

FIG. 10A shows a method 1000A for training a graph neural network based recommendation system in some embodiments of the invention. The method 1000A is a computer-implemented method. The method 1000A includes a multi-stage (e.g., two-stage) training. In some embodiments, the method 1000A can be considered as belonging to the multi-stage training operation 206 in FIG. 2 or step 308 in the method 300 of FIG. 3. The method 1000A includes, in step 1002A, training one or more graph neural network based recommender models of the graph neural network based recommendation system using the graph representation data, such as that obtained in step 304 in the method 300 of FIG. 3, and in step 1004A, training one or more graph neural network based recommender models of the graph neural network based recommendation system using the modified graph representation data, such as that after an edge addition operation (such as the edge addition operations in FIGS. 4 and 5) or that obtained after an edge drop operation (such as the edge drop operations in FIGS. 6 and 7) or that obtained after a node synthesis operation (such as the node synthesis operation in FIGS. 8-9B). As the graph representation data may provide a better representation of the head items (items with more user interactions) and the modified graph representation may provide a better representation of the tail items (items with more less interactions), the method 1000A enables the one or more graph neural network based recommender models of the graph neural network based recommendation system to first learn quality representations of the head items (items with more user interactions), which is easier to learn, and then learn quality representations of the tail items (items with more less interactions), which is more difficult to learn. This can improve the quality of the training of the one or more graph neural network based recommender models of the graph neural network based recommendation system. In some embodiments, the method 1000A includes, as part of the training, optimizing a loss function that takes into account, at least or only, recommendation loss and regularization loss.

FIG. 10B shows a method 1000B for performing graph contrastive learning to train a graph neural network based recommendation system in some embodiments of the invention. The method 1000B is a computer-implemented method. The method 1000B includes, in step 1002B, training one or more graph neural network based recommender models of the graph neural network based recommendation system using graph contrastive learning technique. In some embodiments, the graph contrastive learning technique includes graph representation data modification and noise injection operations. In some embodiments, the method 1000A includes, as part of the training, optimizing a loss function that takes into account, at least or only, contrastive loss, recommendation loss and regularization loss.

While not illustrated, some embodiments of the invention concern using or operating a graph neural network based recommendation system. The use or operation includes processing user data and item data, using one or more graph neural network based recommender models of the graph neural network based recommendation system trained using any one or more of the methods of the invention, to determine an item recommendation for a user. The use or operation may also include presenting (e.g., displaying) the item recommendation. The item recommendation may include one or more items recommended to the user.

The following description provides some example frameworks for training graph neural network based recommendation system in some embodiments of the invention. In some embodiments, the example frameworks can be considered as specific example implementation of: the framework 200 in FIG. 2 and/or the one or more of the operations in FIGS. 3 to 10B.

Inventors of the present invention have appreciated, through their research, that recommendation systems have been adopted in various domains, and that the data sparsity problem (i.e., lack of or limited availability of some data in real world) may degrade the performance of recommendation systems. Inventors of the present invention have discovered that: in recommender applications, behaviors of users typically follow a long-tail distribution, i.e., users may provide much more feedback on popular items (i.e., head items) than on unpopular items (i.e., tail items), even though tail items may also be useful, e.g., for enhancing user experience and boosting revenue for service provider. As a result, conventional recommendation systems and methods may not be able to make relatively accurate predictions for tail items.

### Example 1

To date, various methods for solving the long-tail recommendation problem exist. These methods include, e.g., resampling strategies, transfer learning or meta learning methods, and graph contrastive learning methods. Resampling strategies resort to under-sampling and over-sampling strategies to modify the data distribution. Transfer learning-based methods aim to transfer the knowledge from head items to tail items. Graph contrastive learning-based methods apply a contrastive learning-based method to build more robust representation learning for features to deal with the highly skewed data, which may benefit the performance for items located at the long-tail part. While these existing methods may improve long-tail recommendation performance, they may still have limitations. For example, data resampling methods may affect the performance of head items since they change the data distribution during the training stage. For example, transfer learning or meta learning methods may rely heavily on user/item features to attain rich information so, without sufficient side information (e.g., user/item features), these methods may not be able to extract enough knowledge for knowledge transfer. Indeed, in practice, such side information may not always be available, and this limits the application of such methods. For example, some existing graph contrastive learning methods only use one kind of augmentation (e.g., edge perturbation, add noise), which may not be enough to learn a good or useful representation. Besides, augmentation-based graph contrastive learning methods typically build random uniform graph augmentation. However, these methods may not be able to learn expressive representations for tail items, as the number of edges for tail items are insufficient.

In view of the above, some embodiments of the invention provide a framework for addressing the long-tail recommendation problem. The framework is referred to as a graph contrastive learning-based framework with adaptive augmentation for long-tail recommendation (“GALR”). Generally, GALR includes graph topology augmentation, with adaptive edge dropping and adaptive edge addition, and graph data (training data) augmentation, with training triplet resampling and mixup. By conducting adaptive edge addition, GALR makes the tail items aggregate information from homogenous head items and heterogeneous users, which have richer information. Thus, the recommendation performance for tail items could be improved. Compared with random edge dropping, adaptive edge dropping can preserve more of the important edges for the tail items and drop more of the unimportant edges for the head items, which can facilitate representation learning for the tail items. The augmentation for training data could provide more training triplets to alleviate the data sparsity problem. Moreover, the incorporation of graph contrastive learning could help to learn more uniform and robust representations. In some embodiments, there is provided an adaptive augmentation framework for addressing the long-tail recommendation problem using edge addition and graph topology augmentation. In some embodiments, training data augmentation is applied to force the neural network model to learn more about the tail part. In some embodiments, nodes for augmentation are selected based on performance improvement through a bilateral branch network.

In respect of long-tail recommendation, inventors of the present invention have, through their research, determined that methods for long-tail recommendations can be classified into several types including clustering, deep learning, and graph-based methods. For example, Huang et al., Correcting sample selection bias by unlabeled data (2006), discloses a re-balancing solution that addresses the long-tail problem by generating resampling weights directly to select samples. For example, Park et al., The long tail of recommendation systems and how to leverage it (2008), discloses a clustered tail method, which uses clustering techniques to group tail items and subsequently recommend tail items based on ratings within the clusters. For example, Grozin et al., Similar Product Clustering for Long-Tail Cross-Sell Recommendations (2017), discloses a clustering method, which uses the user and item data as well as some distance metrics for cross-sell recommendation based on association rule mining. For example, Zhang et al., A model of two tales: Dual transfer learning framework for improved long-tail item recommendation (2021), discloses MIRec, a dual transfer learning framework to transfer the model-level and item-level knowledge from head to tail. For example, Liu et al., Long-tail session-based recommendation (2020), discloses Tail-Net, a preference mechanism, which includes session representation and rectification factors generation, to softly adjust the recommendation model and may recommend more long-tail items. For example, Yin et al., Challenging the long tail recommendation (2012), discloses a random walk solution for the long-tail recommendation. For example, Yao et al., Self-supervised learning for large-scale item recommendations (2021), discloses the use of contrastive learning to enhance the feature representation learning and to improve recommendation performance.

Problematically, however, these existing methods related to long-tail recommendation either require rich (abundant) side information or ignore the individual identity of tail items (i.e., recommend a cluster of target tail items instead of an individual item). Unlike these existing methods, in some GALR embodiments as explained in more detail below, graph augmentation is conducted to transfer the information from the head items to the tail items, to help learn better representations for the tail items.

In respect of data augmentation, inventors of the present invention have, through their research, determined that data augmentation methods may include data resampling and data mixup. For example, as illustrated in Estabrooks, A multiple resampling method for learning from imbalanced data sets (2004), and in Huang et al., Correcting sample selection bias by unlabeled data (2006), data resampling methods can be used for dealing with imbalanced data by changing the training data distribution. For example, as illustrated in Zhang et al., Mixup: Beyond empirical risk minimization (2017), data mixup methods can be used to synthesize new data samples by combining existing data samples and their corresponding labels. Inventors of the present invention have further determined that graph data augmentation learning could help to alleviate the incomplete/imbalanced data or noise data in graph structure, and that example techniques for graph augmentation learning include node dropping, edge adding/dropping, and attribution completion. However, these techniques are mostly used for homogenous graphs, and cannot be used directly in recommendation applications in which the user-item graph is bipartite. For example, Rong et al., DropEdge: Towards Deep Graph Convolutional Networks on Node Classification (2019), teaches DropEdge that randomly removes graph edges in the message-passing mechanism to alleviate over-smoothing. For example, Volkovs et al., DropoutNet: Addressing cold start in recommendation systems (2017), teaches DropoutNet that applies dropout during the training process to address the cold start problem in recommendation systems. For example, Wang et al., NodeAug: Semi-supervised node classification with data augmentation (2020), teaches NodeAug that creates a parallel universe for each node for Data Augmentation to deal with negative influences from other nodes. For example, Zhao et al., Data augmentation for graph neural networks (2021), teaches GAUG that introduces graph data augmentation framework to improve performance in GNN-based node classification via edge prediction. For example, Zhou et al., Data augmentation for graph classification (2020), introduces data augmentation on graphs and presents two heuristic algorithms, random mapping and motif-similarity mapping, which generate more weakly labeled data for small-scale benchmark datasets via heuristic modification of graph structures. Inventors of the present invention have further determined that some other techniques combine graph data augmentation with contrastive learning. For example, Zhu et al., Graph contrastive learning with adaptive augmentation (2021), discloses a graph contrastive representation learning method with adaptive augmentation that incorporates various priors for topological and semantic aspects of the graph. For example, Suresh et al., Adversarial graph augmentation to improve graph contrastive learning (2021), discloses a principle called adversarial-GCL, which enables graph neural network (GNNs) to avoid capturing redundant information during training by optimizing adversarial graph augmentation strategies used in graph contrastive learning (GCL).

Despite these teachings, inventors of the present invention have found that there has been no or limited studies on graph data augmentation learning in recommendations. Inventors of the present invention have discovered, through their own research and trials, that graph data augmentation learning may be particularly useful to mitigate the adverse effect of the long-tail distribution. Thus, in some GALR embodiments as explained in more detail below, adaptive augmentation method is applied to address the long-tail recommendation problem.

Further details of the GALR in some embodiments are now provided.

Without loss of generality, in one example, a triple [symbol] U, I, R [symbol] is defined, where U={u₁, u₂, . . . , uₘ} denotes the set of m users, I={i₁, i₂, . . . , iₙ} denotes the set of n items, and R={r₁, . . . , rₚ} denotes the user feedback on the items. In this example, the cumulative item occurrences in all user-item interactions yield a long-tail distribution. A user-item bipartite graph G=(V, E) (similar to one in FIG. 1A) can be constructed, with the node set V including 20 two types of nodes, user nodes and item nodes, and E representing the set of edges. An edge exists between a user node and an item node if the user represented by the user node has provided feedback on the item represented by the item node. In one example, a top-K recommendation model (K is an integer) seeks to recommend K most relevant items to each user and maximizes the average recommendation performance.

In some embodiments, GALR is arranged to improve the recommendation performance of tail items (in addition to the average recommendation performance across all the items).

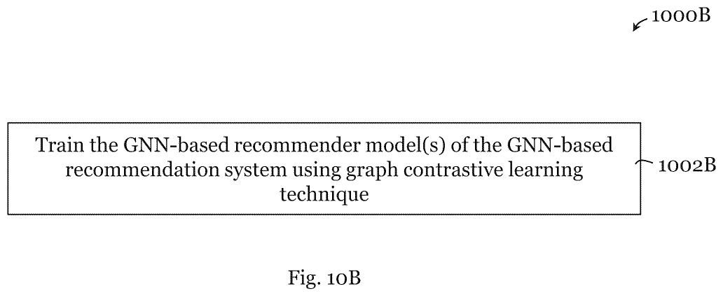

FIG. 11 shows the GALR in some embodiments, which generally includes various features/modules.

As an overview, in some embodiments of GALR, graph topology augmentation, i.e., adaptive homogenous edge addition and adaptive heterogeneous edge dropping, are performed. Through adaptive homogenous edge addition, message passing in the graph model is enhanced by explicitly introducing high-order homogeneous neighbors for tail items. Through adaptive heterogeneous edge dropping, the representation learning could become more robust and over-smoothing problem could be avoided or ameliorated. In some embodiments, the critical graph structure for the tail nodes is preserved, which is advantageous. In some embodiments, a bilateral branch network is applied to compare the performance for each item node. Based on the performance comparison, appropriate item nodes are selected for augmentation. By augmenting the selected nodes, the graph model is encouraged to learn more about the tail part or tail nodes. Further, in some embodiments, self-supervised learning is incorporated and contrastive loss is added by comparing two augmented graph views, to reinforce the representation learning with self-discrimination.

In some embodiments of GALR, adaptive homogenous edge addition is applied.

In some embodiments of GALR, graph augmentation learning is applied to long-tail recommendation, such that the tail items could obtain some information from neighbors. Since the head item nodes have more connections than the tail item nodes in the graph, it is assumed that head item nodes can learn better graph structure information in their embeddings. Thus, some embodiments aim to pass the message from head item nodes to tail item nodes. In some embodiments of GALR, homogenous edges, i.e., item-item edges that connect item nodes, are added to improve graph connectivity for tail item nodes and thus benefit long-tail performance. To this end, an item-item similarity graph is first constructed to find structural neighbors for tail item nodes. Then, the homogenous item nodes are clustered into different groups to find semantic neighbors for tail item nodes. In one example, it is assumed that nodes within the same group have similar interests and nodes in different groups have different/diverse interests. Note that in some embodiments of GALR, edges for both structural and semantic neighbors (item nodes) are added to improve the graph connectivity. In some embodiments of GALR, message passing and aggregation are further performed for the augmented graph.

In some embodiments, adaptive homogenous edge addition includes finding structural neighbors. An item-item similarity graph can be constructed to find structural neighbors. First, item similarity matrices are calculated solely based on the interactions Y between users and items. The item similarity matrix is a M×M matrix, with each element being a co-interaction value between two items. In some embodiments, the definition of the co-interaction value between two users is the number of items they have both interacted with, and the co-interaction value between two items is the number of users who have interacted with both of them. Mathematically, the item similarity matrix can be calculated as

$${S}^{I} = {Y}^{T} \cdot Y ∈ {R}^{M \times M} \qquad ( 1 )$$

Note that in some other embodiments, the framework can use other definitions of co-interaction values, such as Pearson correlation, cosine distance, Jaccard similarity, etc. Then, the co-interaction values for each tail item can be sorted to get the structural neighbors.

In some embodiments, adaptive homogenous edge addition includes finding semantic neighbors. Some studies have shown that high-order neighbors may negatively affect the performance if the interests are different. Therefore, simply adding homogenous edges for all items may not be suitable because items with different kinds or interests might pass irrelevant information and interfere with representation learning. Thus, in some embodiments, it is preferred to find semantic neighbors (in addition to structural neighbors). To this end, in some embodiments, clustering is conducted to cluster similar items. The clustering may be performed using clustering method such as K-means (e.g., as disclosed in MacQueen et al., Some methods for classification and analysis of multivariate observations (1967)), mean-shift (e.g., as disclosed in Comaniciu et al., Mean shift: A robust approach toward feature space analysis (2002)), etc. In this example, K-means is used to cluster the items into several groups or clusters. Items within the same cluster are considered to be semantic neighbors.

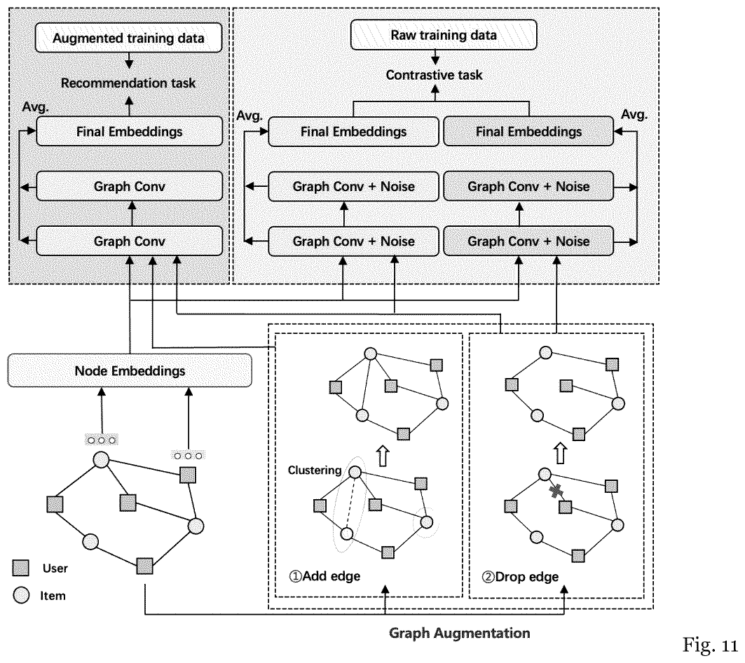

In some embodiments, message passing is performed. After graph construction and augmentation, neighborhood information can be aggregated to reinforce self node representation. FIG. 12 illustrates a message passing operation in GALR in some embodiments of the invention. Take a tail item node as an example. In this example, the tail item's structural neighbors are denoted as Nₒ^{str}(i) and the tail item's semantic neighbors are denoted as Nₒ^{sma}(i). Then the tail item's homogeneous neighbors is Nₒ(i)=Nₒ^{str}(i)∪Nₒ^{sma}(i). Also define the item's heterogeneous neighbors as Nₑ(i). Similarly, Nₒ(u) and Nₑ(u) represent the user's homogeneous neighbors and heterogeneous neighbors respectively.

To update the representation of the item node at layer t (of the GNN), the representations of the item node's neighbors at layer t−1 are first aggregated and then combined with the item node's own representation. The process can be denoted as follows:

$${h}_{N ( i )}^{t} = AGGREGATE ( \{ {h}_{v}^{t - 1} , {∀}_{v} ∈ {N}_{o} ( i ) ⋃ {N}_{e} ( i ) \} ) \qquad ( 2 )$$

$${h}_{i}^{t} = COMBINE ( {h}_{i}^{t - 1} , {h}_{N ( i )}^{t} )$$

where h_{N(i)}^{t} is ID embedding of item node i at layer t, AGGREGATE( ) denotes neighbor aggregation function, such as averaging or maxpooling operation, and COMBINE( ) denotes the function that merges the aggregated neighborhood representation with the node's representation. An example is to use averaging operation, which is relatively simple. Another example is to use attention mechanism, which may be, e.g.:

$${h}_{{N}_{o} ( i )}^{t} = {\sum }_{p ∈ {N}_{o} ( i )} {α}_{i , p}^{t} {h}_{p}^{t - 1} \qquad ( 3 )$$

$${α}_{i , p}^{t} = \frac{exp ( LeakyReLU ( {a}_{i , t}^{T} [ {h}_{i}^{t - 1} ‖ {h}_{p}^{t - 1} ] ) )}{{\sum }_{k ∈ {N}_{o} ( i )} exp ( LeakyReLU ( {a}_{i , t}^{T} [ {h}_{i}^{t - 1} ‖ {h}_{k}^{t - 1} ] ) )}$$

where α_{i,p}^{t} is the normalized attention weight of homogeneous neighbor node p at layer t, α_{i,t} means each layer uses its own attention parameters, the operator ∥ denotes concatenation, and LeakyReLU( ) is used as the activation function.

After obtaining T layers representations, a readout function is used to generate the final representations for prediction:

$${h}_{i} = READOUT ( {h}_{i}^{t} \vert t = [ 0 , … , T ] ) \qquad ( 4 )$$

In this example, the weighted sum operation is used as the READOUT( ).

In some embodiments, a similar procedure is applied for the user nodes. However, as user nodes do not have homogeneous neighbor nodes, the process is described as:

$${h}_{N ( u )}^{t} = AGGREGATE ( \{ {h}_{v}^{t - 1} , {∀}_{v} ∈ {N}_{e} ( u ) \} ) \qquad ( 5 )$$

$${h}_{u}^{t} = COMBINE ( {h}_{u}^{t - 1} , {h}_{N ( u )}^{t} )$$

$${h}_{u} = READOUT ( {h}_{u}^{t} \vert t = [ 0 , … , T ] )$$

In some embodiments of GALR, adaptive heterogeneous edge dropping is applied.

In Rong et al., DropEdge: Towards Deep Graph Convolutional Networks on Node Classification (2019), it is shown that edge drop is simple yet effective in enhancing the representation learning for the graph as well as alleviating the over-smooth problem. However, treating each edge the same may not be suitable. In long-tail recommendation, the tail item nodes are connected with fewer edges than the head item nodes. Therefore, in long-tail recommendation, the edges for tail item nodes are more critical than the edges for head item nodes. Dropping too many edges for tail item nodes may destroy the local graph structure, undesirably affect the message-passing process, and degrade the long-tail performance.

To address this problem, some embodiments apply adaptive heterogeneous edge dropping, i.e., to drop more edges for head items and drop less edges for tail items. In some embodiments, the extent to which a node is located at the tail position is first defined. One example is to use the node degree. However, if node degree is used, a relatively large gap may exist for nodes located at the head part and nodes located at the tail part. To address this problem, in another example, a long-tail coefficient that describes the extent to which a node is located at the tail position is first defined. Specifically, in one example, the long-tail coefficient for item node iₖ, LCᵢₖ, is denoted as:

$${LC}_{ik} = min ( log {( {degree}_{{i}_{k}} + 1 )}^{- 1} , {l}_{c} ) \qquad ( 6 )$$

where degreeᵢ_{ₖ} is the node degree for item node iₖ, and a larger long-tail coefficient value means the node is in a more severe long-tail phenomenon, l_{c} is a cutoff number. Then the adaptive edge-dropping process is formulated. Formally, the edge-dropping process is denoted as:

$$s ( G ) = ( V , M ⊙ ε ) \qquad ( 7 )$$

where s( ) is stochastic selection, M∈{0,1}^{|ε|} is a masking vector on the edge set ε. Suppose the edge drop probability for user u and item i is pᵤᵢ^{e}, then it is defined as:

$${p}_{ui}^{e} = max ( \frac{{LC}_{max}^{e} - {LC}_{ui}^{e}}{{LC}_{max}^{e} - {LC}_{min}^{e}} \cdot {p}_{e} , {p}_{c} ) \qquad ( 8 )$$

where pₑ is a hyper-parameter that controls the overall probability of removing edges, LCₘₐₓ^{e} and LCₘᵢₙ^{e} are the maximum and minimum of LCᵤᵢ^{e}, and p_{c}<1 is a cut-off probability.

In some embodiments of GALR, training triplet resampling and mixup are applied.

Data augmentation (e.g., data resampling, data mixup, etc.) is a model-agnostic technique for dealing with the data imbalance problem. By repeatedly drawing samples or synthesizing samples from training data, the model could be arranged to focus more on the tail part. For long-tail recommendation, one way to select nodes to conduct data augmentation is to split by item node degree, i.e., split the item node into head part and tail part, and only augment the tail part. However, this way may not be optimal in some cases because not all of the low degree nodes perform poorly and so treating every tail item the same may not be optimal. It is believed that poor performance for an item node may be due to two reasons: low frequency and noisy. In respect of low frequency, if the item node occurs more, it could perform better. In respect of noisy, even if the item node is given more occurrences, since it is noisy, its performance may not be improved. Thus, it is useful to select an appropriate method as noisy nodes could not be improved given data augmentation.

To this end, in some embodiments, item nodes that could improve performance are picked instead of low-degree ones.

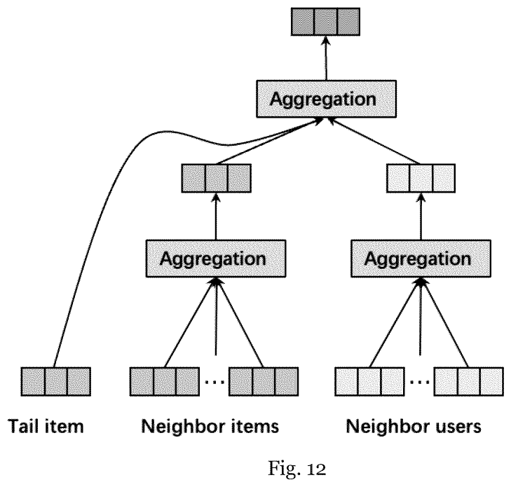

FIG. 13 shows a training data augmentation operation in GALR in some embodiments of the invention. In some embodiments, a bilateral branch network is designed to select appropriate nodes to augment. As shown in FIG. 13, the bilateral branch network includes two generally identical branches each with its respective GNN-based recommendation model(s). In one branch, the raw data remains unchanged. In another branch, some nodes are sampled and data augmentation is conducted. In some embodiments, two methods for conducting data augmentation are adopted: data mixup and data resampling. For data mixup, given two interacted user-item-rating triplet pairs, denoted as [symbol] uₚ, iₘ, rₖ [symbol] and [symbol] uₚ, iₙ, rₜ [symbol] , where uₚ is the user with corresponding embedding eₚ, and iₘ and iₙ are the items with corresponding embedding eₘ and eₙ. Data mixup is performed on these two pairs, to obtain ĩ=λiₘ+(1−λ)iₙ, where the embedding for item ĩ is \tilde{e}=λeₘ+(1−λ)eₙ, and A is a hyper-parameter. For data resampling, some embodiments repeatedly draw samples or dropout samples from the training data. Formally, denoted the raw data as D. For dᵢ∈D and dᵢ= [symbol] uₐ, i_{b}, r_{c} [symbol] . For data resampling, d′ᵢ= [symbol] uₐ, i_{b}, r_{c} [symbol] ; for data mixup, d′ᵢ= [symbol] u′ₐ, i′_{b}, r′_{c} [symbol] . Suppose wₒ number of entries of data is added, the augmented data is denoted as D =D∪{d′₁, . . . , d′_{w}_{ₒ}}.

Then, the GNN-based recommendation model(s) of each branch is trained. One branch is trained using raw training data. Another branch is trained using augmented training data (raw training data+synthesized training data). The GNN-based recommendation model(s) may be, e.g., NGCF, PinSage, LightGCN, etc. The process is denoted as:

$${Θ}_{1} = f ( {Θ}_{init} , G , D ) \qquad ( 9 )$$

$${Θ}_{2} = f ( {Θ}_{init} , G , {D}^{′} )$$

where Θᵢₙᵢₜ is the initial parameter for the model, D is the training data, G is the graph, and D′ is the augmented training data, ƒ( ) is the calculation by the specific GNN(s).

In some embodiments, node performance for each item node is compared, and the performance improvement is denoted as Δp, defined as:

$$Δ p = {p}_{i}^{′} - {p}_{i} \qquad ( 10 )$$

where pᵢ is the performance for item node i in the branch trained with the raw data, and pᵢ is the performance for item node i in the other branch. Then, the item node(s) that could achieve performance improvement greater than a threshold θ, i.e., Δp>θ are chosen. θ is a hyper-parameter, which, in this example, is set to 0. The sampling process is repeated until all candidate nodes are covered. Then the selected item set (item nodes set) is obtained for data augmentation. In some embodiments, an adaptive training data augmentation scheme is designed. It is believed that item node that improves less require more data augmentation to achieve satisfactory performance. Suppose w is the weight to control the extent of data augmentation, then it is defined as:

$${w}_{i} = max ( \frac{Δ {p}_{max} - Δ {p}_{i}}{Δ {p}_{max} - Δ {p}_{min}} \cdot {w}_{e} , {w}_{c} ) \qquad ( 11 )$$

where w is a hyper-parameter that controls the overall probability of adding edges, Δpₘₐₓ and Δpₘᵢₙ is the maximum and minimum of Δp, and w_{c} is the cut-off value. Then, the adaptively augmented data D″ is used to train the GNN model(s) (same as the one in any of the branches in the bilateral branch network, denoted as:

$${Θ}_{final} = f ( {Θ}_{1} , G , {D}^{″} ) \qquad ( 12 )$$

In some embodiments of GALR, contrastive learning is applied.

Contrastive learning can improve representation learning by learning more uniform distribution and thus could improve the model performance. For graph contrastive learning, one way is to generate two augmented views for a graph. The method may include edge/node perturbation. For example, Wu et al., Self-supervised graph learning for recommendation (2021), teaches SGL with graph augmentation such as random edge dropping. For example, Zhu et al., Graph contrastive learning with adaptive augmentation (2021), teaches GCA in which more central and critical graph structures are preserved. However, for tail items, as they have less edges, treating them the same as or less important than head items may not be suitable for improving long-tail performance. Dropping edges for the tail items may lose relatively important information since tail items have rather limited number of edges, and each edge takes higher responsibility for message passing. Therefore, in some embodiments, an adaptive graph augmentation-based contrastive learning method is applied. Specifically, the edge perturbation is more likely to occur for head items than tail items to preserve the graph structure and enable the message passing for tail items.

Formally, in some embodiments, two augmentation methods are mixed to generate graph views since a single augmentation may not be enough. One augmentation method is graph perturbation, including adaptive edge addition and adaptive edge dropping described. Another augmentation method is to add noise to embeddings and compare embedding with different layers, following SimGCL (as disclosed in Yu et al., Are graph augmentations necessary? Simple graph contrastive learning for recommendation (2022)) to learn a more uniform distribution for embeddings. In some embodiments, contrastive loss, InfoNCE (as disclosed in Gutmann et al., Noise-contrastive estimation: A new estimation principle for unnormalized statistical models (2010)), is adopted to maximize the agreement of positive pairs and minimize that of negative pairs. Suppose the e′ᵤ and e″ᵤ are the user embedding for two views and e′ᵢ and e″ᵢ are the item embedding for two views generated by adaptively edge drop, then the contrastive loss [symbol] _{cl} is denoted as:

$${ℒ}_{c l}^{u s e r} = {\sum }_{u ∈ U} - log \frac{exp ( s ( {e}_{u}^{′} , {e}_{u}^{″} / τ ) )}{{Σ}_{u ∈ U} exp ( s ( {e}_{u}^{′} , {e}_{u}^{″} / τ ) )} \qquad ( 13 )$$

$${ℒ}_{c l}^{item} = {\sum }_{i ∈ I} - log \frac{exp ( s ( {e}_{i}^{′} , {e}_{i}^{″} / τ ) )}{{Σ}_{i ∈ I} exp ( s ( {e}_{i}^{′} , {e}_{i}^{″} / τ ) )}$$

$${ℒ}_{cl} = {ℒ}_{c l}^{u s e r} + {ℒ}_{c l}^{i t e m}$$

where s( ) measures the similarity between two vectors, which is set as cosine similarity function; z is the hyper-parameter, known as the “temperature” in softmax. In this way, the representation learning could be enhanced and facilitate the model training.

In some embodiments of GALR, a specific training strategy is applied.

After obtaining the user embeddings and item embeddings via the GNN based model(s), the inner product of the user and item embeddings is used to estimate the user's preference towards a target item. Specifically, the model prediction for user uⱼ towards item iₖ is denoted as:

$${\hat{y}}_{{u}_{i}} = {e}_{{u}_{j}}^{T} {e}_{{i}_{k}} \qquad ( 14 )$$

In some embodiments, the BPR loss (as disclosed in Rendle et al., BPR: Bayesian personalized ranking from implicit feedback (2012)) is used to encourage the prediction of an observed user-item pair to be higher than its unobserved counterparts, denoted as:

$${ℒ}_{c l} = - {\sum }_{u = 1}^{M} {\sum }_{i ∈ {N}_{u}} {\sum }_{i ∉ {N}_{u}} ln σ ( {\hat{y}}_{{u}_{i}} - {\hat{y}}_{{u}_{j}} ) \qquad ( 15 )$$

In some embodiments, the overall loss is the sum of recommendation loss, regularization loss, and contrastive loss, denoted as:

$${ℒ}_{o v e r a l l} = {ℒ}_{b p r} + {γ}_{1} {ℒ}_{c l} + {γ}_{2} {‖ Θ ‖}_{2}^{2} \qquad ( 16 )$$

where Θ is the model parameter, γ₁ and γ₂ are hyperparameters controlling the strength of contrastive loss and L₂ regularization loss respectively. In some embodiments, the Adam optimizer (as disclosed in Kingma et al., Adam: A method for stochastic optimization (2014)) is applied to optimize the loss function to minimize the loss.

To evaluate the performance and analyze various components of the GALR in some embodiments, experiments are performed on four real-world datasets from different domains.

Specifically, experiments are performed to determine how GALR performs compared with existing baseline methods with respect to overall performance and long-tail performance, to determine how the incorporation of adaptive augmentation and contrastive loss in GALR may affect the recommendation performance, and to determine how the hyper-parameters may affect the GALR performance.

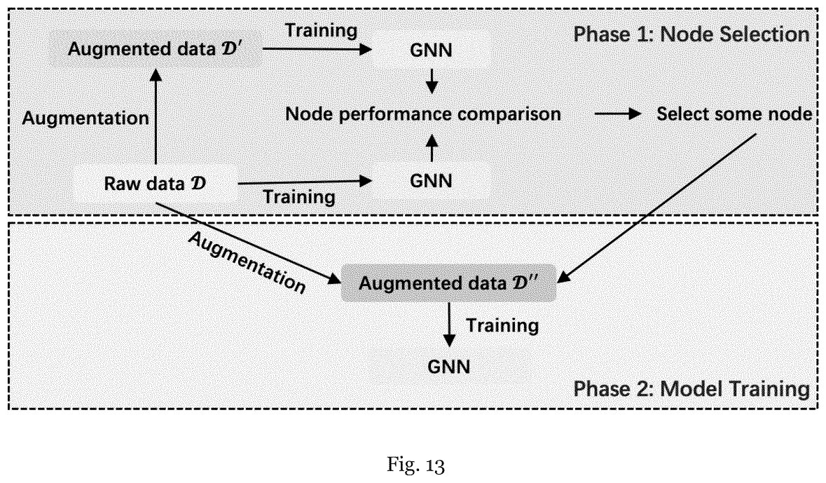

In this example, the experiments are conducted on four publicly-available real-world datasets, details of which is shown in FIG. 14:
(1) MovieLens (https://grouplens.org/datasets/movielens/)
   MovieLens is a movie rating dataset that is used for evaluating recommendation algorithms. In this example, MovieLens-1M (ML-1M), which includes around 1,000,000 user ratings, is used.
(2) Douban-book (https://github.com/librahu/HIN-Datasets-for-Recommendation-and-Network-Embedding)
   Douban-book contains users' ratings of books.
(3) Yelp2018 (https://www.yelp.com/dataset/challenge)
   Yelp2018 is from the Yelp-2018 challenge and it relates to the task of recommending business webpages to users.
(4) Amazon-Book (https://jmcauley.ucsd.edu/data/amazon/)
   Amazon-Book is from the Amazon review data for recommending books to users.

In the experiments, the GALR in some embodiments is compared with existing model-agnostic baseline methods (including data reweighting, loss function refinement, and various meta learning, graph augmentation learning, and contrastive learning models). To make a fair comparison, LightGCN is used as the backbone model. The same layers and embedding dimensions are adopted for all models. Specifically, the baseline methods used in the experiments are as follows:
(1) Backbone model:
   LightGCN (as disclosed in He et al., LightGCN: Simplifying and powering graph convolution network for recommendation (2020)): A lightweight model which simplifies the weight parameter aggregation steps in graph convolution network.
(2) Resampling Strategies (as disclosed in Brownlee, Imbalanced classification with Python: better metrics, balance skewed classes, cost-sensitive learning (2020)):
   Over-sampling: sample more from tail items to re-balance the head items and tail items in the training data distribution.
   Under-sampling: keep the tail items unchanged and down-sample the head items in contrast to over-sampling.
(3) Loss function refinement methods:
   Focal Loss (FL) (as disclosed in Lin et al., Focal loss for dense object detection (2017)): reweights the standard loss to assign less weight for well-classified examples.
   ClassBalance (as disclosed in Cui et al., Class-balanced loss based on effective number of samples (2019)): calculates the effective number of samples to reweight loss for each class.
(4) Meta-learning model:
   MeLu (as disclosed in Lee et al., MeLU: Meta-learned user preference estimator for cold-start recommendation (2019)): applies optimization-based meta-learning (MAML) for cold-start item rating prediction.
(5) Graph augmentation learning models:
   DropEdge (as disclosed in Rong et al., DropEdge: Towards Deep Graph Convolutional Networks on Node Classification (2019)): randomly removes graph edges in the message passing mechanism to alleviate over-smoothing.
   Tail-GNN (as disclosed in Liu, et al., Tail-GNN: Tail-node graph neural networks (2021)): adds a tail-node-specific component inside the original GNN.
(6) Contrastive learning models:
   SGL (as disclosed in Wu et al., Self-supervised graph learning for recommendation (2021)): incorporates self-supervised learning into recommendation via graph level augmentation such as edge drop and random walk.
   xSimGCL (as disclosed in Yu et al., XSimGCL: Towards extremely simple graph contrastive learning for recommendation (2022)): injects random noise to embeddings as an augmentation-free method for graph contrastive learning.

Various settings are applied in the experiments in this example.

One of the settings relates to preprocessing. In this example, the experiment setting disclosed in Yu et al., Graph Augmentation Learning (2022) is followed to discard ratings less than 4 in Movielens and Douban-book datasets (which are with a 1-5 rating scale), and to reset the rest to 1. The datasets are split into three parts (training set, validation set, and test set) with a ratio of 7:1:2. Pareto principle (as disclosed in Box et al., An analysis for unreplicated fractional factorials (1986)) is used as the criteria to split the head and tail items. The top ranked 20% number of occurrence of items are set as head items and the rest are set as tail items. The metrics evaluated on the tail and head item sets are reported respectively. The average performance by five runs is reported.

One of the settings relates to evaluation metrics. In this example two evaluation metrics are employed to evaluate the performance: (1) Recall, which measures the chance that the recommendation list contains users' interested items, and (2) a weighted version of hit ratio (HR), called Normalized Discounted Cumulative Gain (NDCG), which puts more weight on items that are ranked higher in the recommendation list. In this example, Recall@K (or simply R@K) and NDCG@K (or simplyN@K), with K∈{20,50}, are evaluated.

One of the settings relates to hyperparameters. In this example, to obtain a fair comparison, the best hyper-parameter settings reported in the publications associated with the baseline methods are referenced and all the hyperparameters of the baseline methods are fine-tuned with grid search. For the general settings of all the baseline methods, Xavier initialization (as disclosed in Glorot et al., Understanding the difficulty of training deep feedforward neural networks (2010)) is used on all the embeddings. In this example, the embedding size is 64, the parameter for L₂ regularization is 10⁻⁴ and the batch size is 2048. The Adam optimizer with a learning rate of 0.001 is used to optimize all the models. For GALR, the structural neighbor number is chosen from {3, 5, 10} and the cluster number is chosen from {3, 5, 10, 20}.

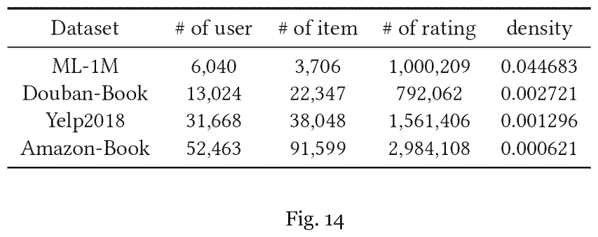

The performance of the baseline methods and the GALR in some embodiments are evaluated using the four datasets to explore the models' performance under different scenarios. FIGS. 15A and 15B contain tables that summarize the recommendation performance of all items, head items, and tail items on these datasets.

Several observations can be made based on the obtained recommendation performance.

First, compared with the backbone model LightGCN, the GALR embodiment generally achieves improvements for both tail and head items. This indicates the importance of considering adaptive graph perturbation and training data augmentation among items in the long-tail item distribution. The result shows the graph augmentation in the GALR embodiment can benefit long-tail distribution recommendation data.

Second, the GALR embodiment outperforms the reweighting methods (i.e., oversampling, under-sampling) on all three splits. Among these methods, over-sampling performs worse than under-sampling on the tail items splits. However, the re-sampling method may change the original data distribution and thus negatively affect the overall model performance. The meta-learning and refining loss function strategies based methods do not achieve superior performance on head and tail items. This verifies that with no model parameters and user/item features, meta-learning methods cannot perform well. The failure of the refining loss function strategies to obtain superior performance may be that the tradeoff between the head items and the tail items is not healthy or may be undesirable. Graph augmentation methods (i.e., DropEdge, Tail-GNN) successfully improve both the head and tail item performance. This shows that by perturbing the graph structure, the model could learn more robust representations.

Third, compared with contrastive learning based models, the GALR embodiment obtains better performance. This demonstrates the usefulness of combining adaptive graph perturbation with contrastive learning to learn more uniform and robust representations. This would benefit the model performance.

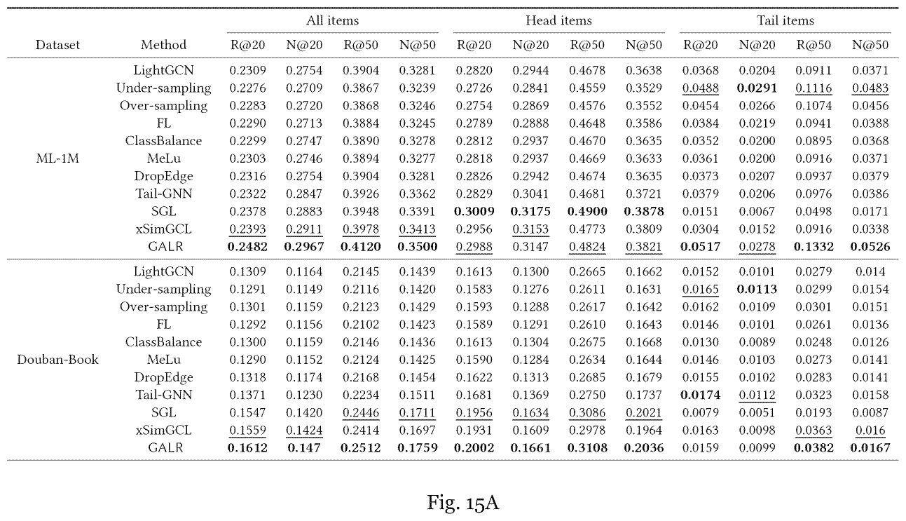

Ablation studies are also performed to analyze different components of the GALR embodiment. FIG. 16 shows the results of the ablation studies. The full GALR embodiment outperforms all GALR variants on three splits, which indicates that all main components in this GALR embodiment can be used to contribute to performance improvement.

The four GALR variants and their results are as follows.

One of the GALR variants is without contrastive loss [symbol] _{cl}. In this variant, the contrastive loss [symbol] _{cl} is removed and only the BPR loss and L₂ normalization loss are used to train the GNN based model(s). From FIG. 16, it can be seen that GALR without contrastive loss [symbol] _{cl} performs poorly. This implies that [symbol] _{cl} could effectively enhance the representation and learn more uniform and robust embeddings. This could improve the recommendation performance.

One of the GALR variants is without adaptive edge dropping. In this variant, the adaptive edge dropping is replaced with random uniform edge dropping (other components remain unchanged). The performance of the GNN based model(s) without the adaptive edge dropping is poor on tail items. This suggests that adaptive edge dropping can benefit the tail item recommendation performance since it could keep more critical graph structure information for tail items.

One of the GALR variants is without adaptive edge addition. In this variant, adaptive edge addition is removed (other components remain unchanged). Without adaptive edge addition, the tail items have obvious performance degradation. This shows that the head items could pass the message to neighbor tail items.

One of the GALR variants is without training triplet resampling and mixup. In this variant, the training triplet resampling and mixup are not applied (other components remain unchanged). It can be seen that the GNN based model(s) performs poorly.

Hyper-parameter studies are also performed.

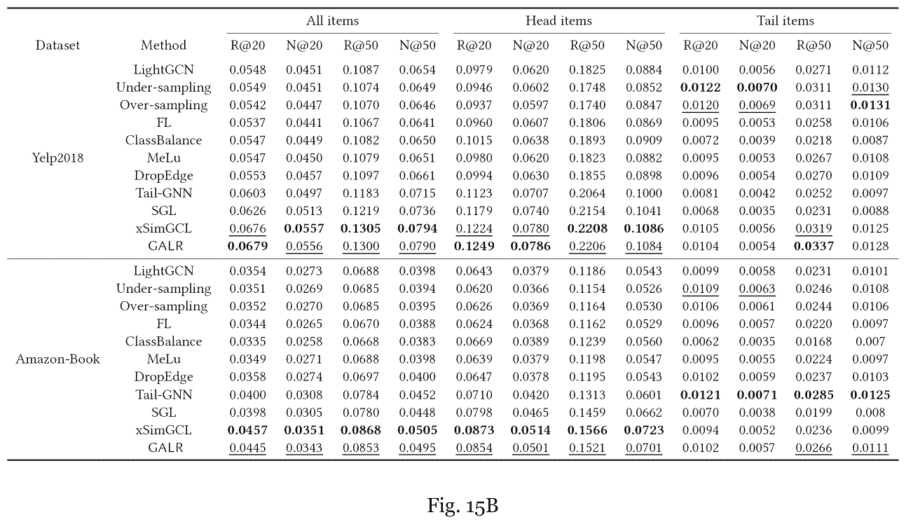

One of the hyper-parameter studies relates to the impact of edge drop rate. FIG. 17 shows the performance change on all three splits according to the edge drop rate. When the edge drop rate=0.9, the graph structure is largely destroyed. Under such circumstances, graph contrastive learning can unlikely learn any useful information and it would be difficult to optimize the contrastive objective.

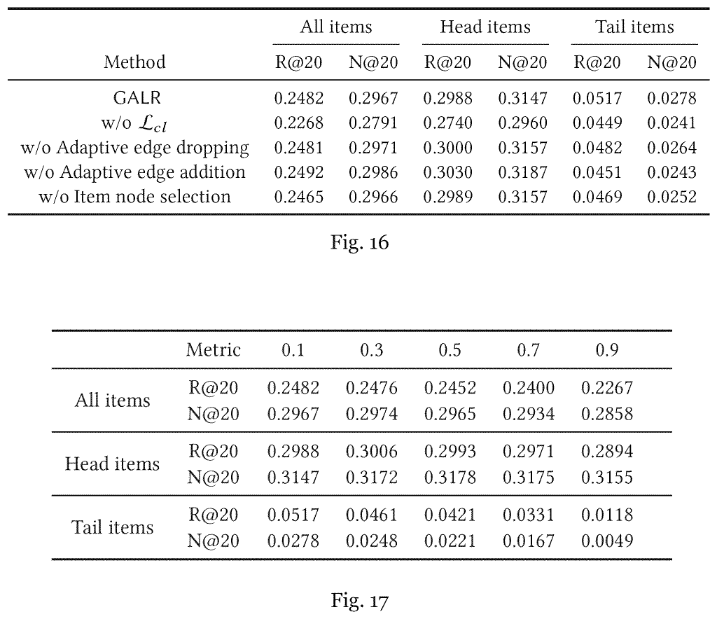

One of the hyper-parameter studies relates to the impact of cluster number. FIG. 18 shows the results. It can be seen that the overall model performance (“all items”) and the tail performance (“tail items”) both first increase then decrease as the cluster number increases. This is because when the cluster number is too large or too small, it is hard to represent the item features. This verifies the cluster number should be carefully selected.

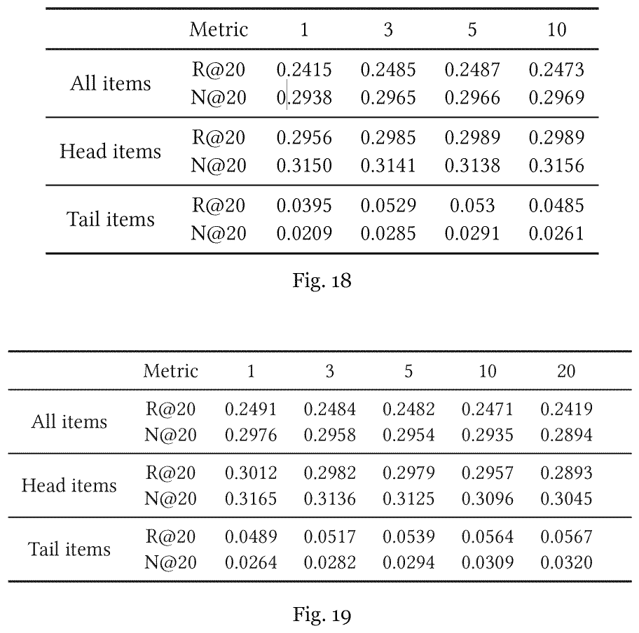

One of the hyper-parameter studies relates to the impact of the number of structural neighbors. FIG. 19 shows the performance of GNN based model(s) with different structural neighbor numbers. The result suggests that, generally, when more structural neighbors are selected, then more messages are passed from the head items to tail items to improve the long-tail performance.

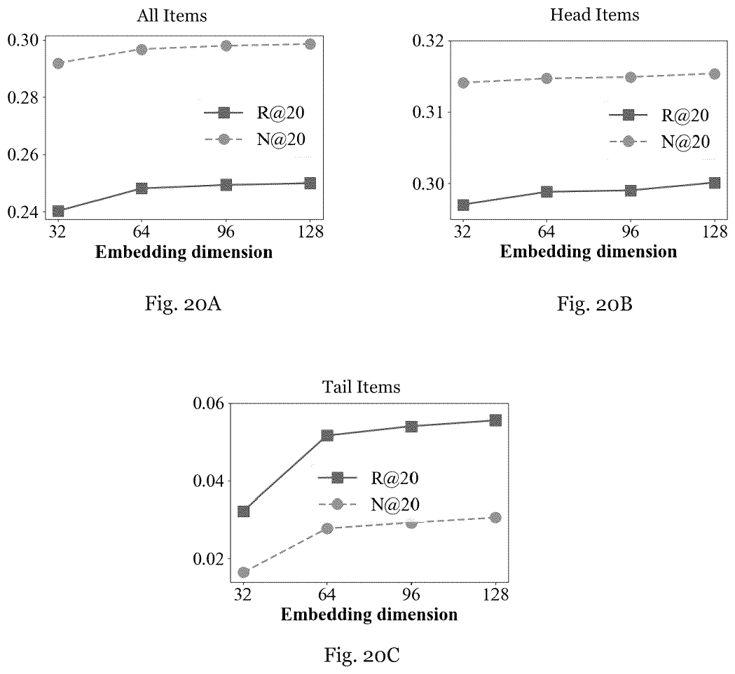

One of the hyper-parameter studies relates to the impact of embedding size or dimension. The influence of the embedding size on the performance of GNN based model(s) is studied. FIGS. 20A to 20C show the result. It can be seen that the performance of the performance of GNN based model(s) normally increases as the embedding size or dimension increases. Nonetheless, when the embedding size larger than 64, the improvement is limited. This may be because in this example an embedding size of 64 is already enough to express the items in the latent space. For the tail items, the impact of the embedding size is more obvious. This may be because a larger embedding size may better express tail items.

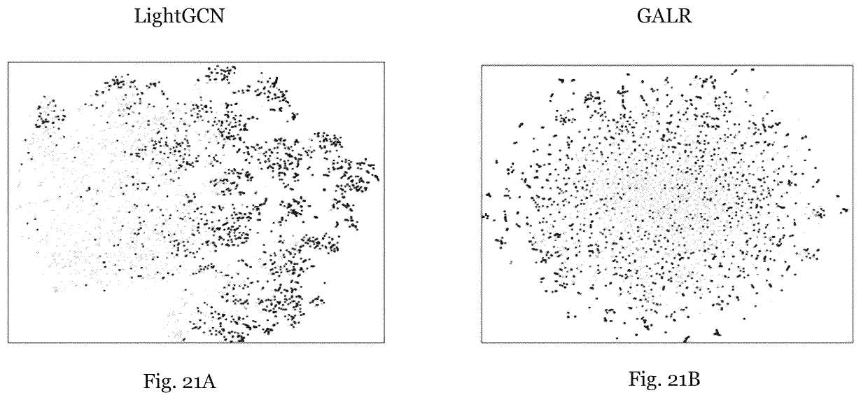

FIGS. 21A and 21B show all learned item embeddings from the LightGCN (FIG. 21A) and the GALR embodiment (FIG. 21B), visualized using t-SNE (as disclosed in Maaten et al., Visualizing data using t-SNE (2008)). It can be seen that for LightGCN the embeddings for the head and tail items are sparser whereas for GALR the embeddings for the head and tail items are closer to each other. In FIGS. 21A and 21B, the lighter, grey dots correspond to head items whereas the darker, block dots corresponding to tail items. This indicates that the message has successfully passed from the head items to the tail items to facilitate the training process. Thus, the approach in this embodiment could enhance the tail item performance.

While the GALR embodiment described above focuses mainly on the long-tail distribution from the item side, it should be appreciated that in other embodiments, GALR could be used in long-tail user recommendations with appropriate modification. For example, a user-user similarity graph may be constructed and/or user-user homogenous edges may be added. Integrating addition of user-user homogenous edges and item-item homogenous edges could make two sides, i.e., user side and item side, long-tail recommendation.

The above embodiments provide some example implementation of a long-tail recommendation model named GALR (i.e., Graph contrastive learning-based framework with adaptive Augmentation for Long-tail Recommendation) for improving recommendation performance on tail items. In some embodiments, adaptive edge adding and edge dropping are designed to make the tail items learn some missing information. In some embodiments, data level augmentation is performed to make the GNN based model(s) focus more on the tail part. In some embodiments, contrastive loss via edge perturbation is used to learn more-uniform representation. The experiments performed on several benchmark datasets demonstrate the effectiveness of GALR.

As mentioned, long-tail distribution of user behaviors (users-items interactions) may result in reduced recommendation performance for items with fewer user records (i.e., tail items) (compared with items with more user records (i.e., head items)). To improve the recommendation performance for the tail items, methods such as migrating knowledge from head items to tail items by transfer learning, incorporating graph contrastive learning to learn better representations for tail items, etc., have been provided. However, these existing methods are not without problems. For example, some existing transfer learning methods rely heavily on rich item/user features, which may not be available in practice. For example, some existing graph contrastive learning-based recommendation methods may adopt only one kind of augmentation (either in feature space or in graph structure space), which may be suboptimal. For example, some existing graph contrastive learning-based recommendation methods may only conduct uniform graph augmentation, which makes it difficult to learn representations for the tail items. In some embodiments of the invention, a graph contrastive learning based framework with adaptive augmentation for long-tail recommendation (herein referred to as “GALR”) is provided. The GALR may address one or more of the above issues. In some embodiments, GALR may include various features: adaptive edge addition is performed by directly introducing high-order homogeneous information for the tail items; adaptive edge dropping is performed to preserve more critical graph structure information for the tail items; message may pass from the well-learned head items to tail items to improve the long-tail performance; a bilateral branch network is applied to select appropriate item nodes for conducting training data augmentation; contrastive learning is incorporated for more robust and uniform representation learning; etc.

### Example 2

To date, various methods for solving the long-tail recommendation problem exist. These methods include data-level methods and algorithm-level methods. For example, some data-level methods may include resampling strategies that modify the data distribution through under-sampling and oversampling techniques. For example, some algorithm-level methods may include transfer learning-based method to transfer knowledge from head items to tail items to improve the recommendation performance of tail items. For example, some algorithm-level methods may include modifying the network structure to solve the long-tail recommendation problem. For example, some algorithm-level methods may utilize multi-objective optimization and adversarial approaches to improve long-tail recommendation performance.

Inventors of the present invention have appreciated, through their research, that existing solutions to the long-tail recommendation problem focus on traditional neural network based models, without utilizing graph-based recommendation models. Inventors of the present invention have appreciated, through their research, existing graph-based recommendation models have limitations. For example, tail items may have limited graph connections, which may restrict their learning ability due to low connectivity. The sparse connectivity of tail items in the graph inhibits adequate information flow during the propagation phase in the graph neural network (GNN), limiting the potential for learning meaningful representations. For example, the training loss is dominated by the head items, making it challenging to learn the tail items. The optimization loss during training tends to be overwhelmingly dictated by the more plentiful head nodes, marginalizing the tail nodes and exacerbating the skewed learning towards the head items. For example, the imbalance between the head and tail items may lead to overfitting on the head items and poor generalization on the tail items.

Based on the above, inventors of the present invention see a need to develop effective graph-based methods that can address the long-tail recommendation problem.

In view of the above, some embodiments of the invention provide a framework for addressing the long-tail recommendation problem. The framework is referred to as graph augmentation framework for long-tail recommendation (“GALORE”). In some GALORE embodiments, item-to-item edge addition for tail items is utilized to improve the connectivity of tail items, thus allowing the tail items to receive messages from nearby, better learned head items. This may improve the recommendation performance for tail items. In some GALORE embodiments, a degree-aware edge dropping process is applied to preserve relatively more important edges for tail items and drop relatively unimportant edges for head items. This process may facilitate representation learning for tail items. In some GALORE embodiments, a node synthesis method that synthesizes new data is applied to mitigate data sparsity for tail items, thus providing more training samples and alleviating the data sparsity problem. The synthetic data can serve as hard negative mining to improve the model performance. In some GALORE embodiments, a multi-stage (e.g., two-stage) training strategy is utilized to facilitate the training process. In some embodiments, there is provided a graph augmentation framework that addresses the long-tail recommendation problem through graph augmentation, which includes both edge addition and edge dropping. By augmenting the graph, the graph connectivity of tail items may be improved for learning better representation for tail items. In some embodiments, there is provided a node synthesis technique to alleviate the data imbalance problem and to allow the model to learn from more data on the tail items. In some embodiments, there is provided a two-stage training strategy that enables the model to learn representations of head items and tail items at different stages.

In respect of long-tail recommendation, inventors of the present invention have, through their research, appreciated various existing solutions. For example, Huang et al., Correcting sample selection bias by unlabeled data. (2006), discloses a rebalancing solution that generates resampling weights directly to select samples. For example, Park et al., The long tail of recommender systems and how to leverage it (2008), discloses a clustered tail method, which utilizes clustering techniques to group tail items and recommends them based on ratings within the clusters. For example, Grozin et al., Similar Product Clustering for Long-Tail Cross-Sell Recommendations (2017), discloses a clustering method that utilizes user and item data and distance metrics for cross-sell recommendation based on association rule mining. For example, Yin et al., Challenging the long tail recommendation (2012), addresses the long-tail recommendation by exploring the item-item similarity graph and utilizing the random walk technique to capture the preference similarity between items. For example, Volkovs et al., Dropoutnet: Addressing cold start in recommender systems. Advances in neural information processing systems (2017), discloses DropoutNet that applies dropout during the training process to address the cold start problem in recommender systems. For example, Liu et al., Long-tail session-based recommendation (2020), discloses TailNet that uses a preference mechanism consisting of session representation and generating rectification factors to adjust the recommendation model and recommend more long-tail items. For example, Zhang et al., A model of two tales: Dual transfer learning framework for improved long-tail item recommendation (2021), discloses MIRec that includes a dual transfer learning framework that transfers model-level and item-level knowledge from head to tail.

Problematically, however, these existing long-tail recommendation algorithms are primarily designed for traditional neural networks and are therefore ill-suited for graph-based recommendation models. Unlike these existing methods, in some GALORE embodiments as explained in more detail below, graph augmentation technique is leveraged to transfer information from better-learned head items to under-learned tail items in the graph view. By facilitating better representation learning for tail items, some GALORE embodiments could improve the recommendation performance for the tail items.

In respect of graph augmentation, inventors of the present invention have, through their research, determined that graph augmentation learning can help alleviate incomplete or noisy data in graph structures. For example, as disclosed in Zhao et al., Graph data augmentation for graph machine learning: A survey (2022), techniques for graph augmentation learning include node dropping, edge addition/dropping, and attribution completion. For example, Rong et al., DropEdge: Towards Deep Graph Convolutional Networks on Node Classification (2019), has disclosed DropEdge, which randomly removes graph edges in the message-passing mechanism to alleviate over-smoothing. For example, Wang et al., Nodeaug: Semi-supervised node classification with data augmentation (2020), creates a parallel universe for each node for data augmentation to deal with negative influences from other nodes. For example, Zhao et al., Data augmentation for graph neural networks (2021) discloses GAUG, which introduces a graph data augmentation framework to improve performance in GNN-based node classification via edge prediction. For example, Zhou et al., Data augmentation for graph classification (2020), discloses data augmentation on graphs and two heuristic algorithms, random mapping and motif-similarity mapping, to generate more weakly labeled data for small-scale benchmark datasets via heuristic modification of graph structures.

Problematically, however, these existing techniques are mostly used for homogeneous graphs but, in recommendation scenarios, the user-item graph in recommendation scenarios is bipartite and these existing techniques cannot be directly applied. Inventors of the present invention believe there is a need to investigate graph augmentation learning in recommendations, which could be useful in mitigating the adverse effect of the long-tail distribution.

Further details of the GALORE in some embodiments are now provided.

Without loss of generality, in one example, consider a set of users denoted by U={u} and a set of items denoted by I={i}. Based on the user-item interactions, a bipartite graph G=(V, E) can be constructed, where V=U∪I is the collection of all the users and items, and ε=U∪I represents the set of edges. An edge exists between user u∈U and item i∈I, namely (u, i)∈ε, if user u has given feedback to item i. The user-item interactions can also be represented by a matrix Y∈{0,1}^{|U|×|I|}, where Y_{u,i}=1 if user u has given feedback to item i (i.e., (u, i)∈ε), and Y_{u,i}=0 otherwise. In this example, the cumulative item occurrences in all the user-item interactions yield a long-tail distribution.

A top-K recommendation model seeks to recommend the K most relevant items to each user and maximizes the average recommendation performance. However, the long-tail distribution implies that some (or many) items may have little feedback, resulting in poor recommendations for these tail items. The GALORE embodiments is arranged to improve the performance of tail items, in addition to the average performance across all the items. To this end, in the GALORE embodiments, graph augmentation is conducted to transfer information from head items to tail items.

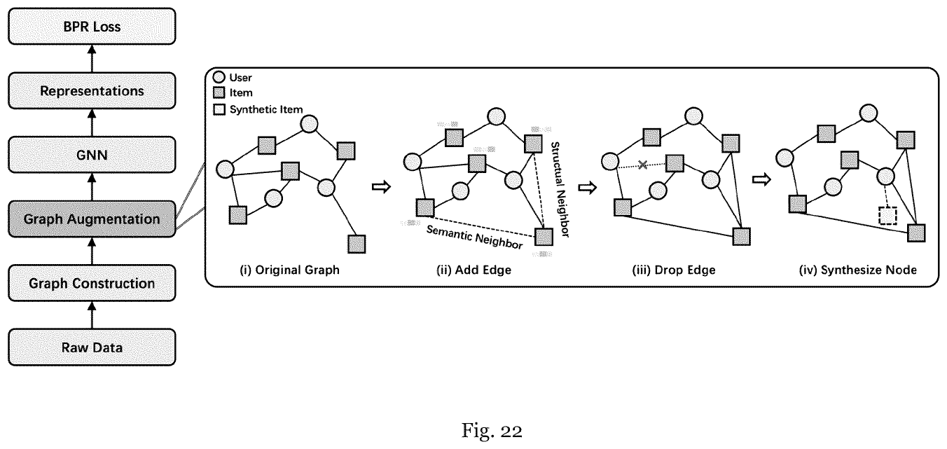

FIG. 22 shows the GALORE in some embodiments, which generally includes various features/modules.

As an overview, in some embodiments of GALORE, a graph augmentation method includes three operations/modules: edge addition, edge dropping, and node synthesis. The edge addition is arranged to add item-item edges to enhance knowledge transfer from head items to tail items. The edge dropping is arranged to selectively drop user-item edges to promote robust representation learning. The node synthesis module is arranged to generate synthetic item nodes to alleviate the long-tail problem. In some embodiments, in GALORE, the training process includes two stages: a first stage that trains on the original bipartite graph to initial item embeddings (in particular, better embeddings for head items), and a second stage that trains on the augmented graph to improve the representations of the tail items. This training strategy can encourage the model to focus on head and tail items separately in different training stages.

In some embodiments of GALORE, edge addition is applied.

In some embodiments of GALORE, graph augmentation learning is applied to long-tail recommendation, such that the tail items can get some missing information from other items. Since the head items have more connections than the tail items, the model usually learns better representations for head items. By connecting tail items to head items, knowledge from head items can be transferred to tail items. More specifically, in some embodiments, homogeneous edges, i.e., item-item edges, are added to improve graph connectivity for tail items and thus benefit long-tail performance. To this end, an item-item similarity graph is first constructed to find structural neighbors for tail item nodes. Then, the embeddings of homogeneous item nodes are clustered into different groups in latent space to find semantic neighbors for tail item nodes. In this example it is assumed that nodes within the same group have similar interests whereas nodes in different groups have diverse interests. Note that in some embodiments of GALORE, both structural and semantic neighbors to improve the graph connectivity. In some embodiments, message passing and aggregation are further performed for the augmented graph.

In some embodiments, edge addition includes finding structural neighbors. An item-item similarity graph can be constructed to find structural neighbors. First, item similarity matrices can be calculated solely based on the interactions Y between users and items. The item similarity matrix is a |I|×|I| matrix, with each element being a co-interaction value between two items. In some embodiments, the definition of the co-interaction value between two users is the number of items they both interacted with, and that between two items is the number of users who interacted with both of them. Mathematically, the item similarity matrix can be calculated as

$${S}^{I} = {Y}^{T} \cdot Y ∈ {R}^{\vert I \vert \times \vert I \vert} \qquad ( 1 )$$

Note that in some other embodiments, the framework can use other definitions of co-interaction values, such as Pearson correlation, cosine distance, Jaccard similarity, etc. Then, the co-interaction values for each tail item can be sorted to get the structural neighbors.

In some embodiments, edge addition includes finding sematic neighbors. Some studies have shown that the inclusion of high-order neighbors may have an adverse effect on performance, particularly if the interests of the neighbors differ. Consequently, the naive addition of homogeneous edges for all items may be sub-optimal, as it can lead to the passing of irrelevant information between items with different characteristics, thereby hindering representation learning. Thus, in some embodiments, it is preferred to identify semantic neighbors, i.e., items that share similar characteristics and are more likely to have a meaningful relationship. To this end, in some embodiments, clustering is conducted to group similar items together in the latent space. The clustering method may include K-means as K-means (e.g., as disclosed in MacQueen et al., Some methods for classification and analysis of multivariate observations (1967)), mean-shift (e.g., as disclosed in Comaniciu et al., Mean shift: A robust approach toward feature space analysis (2002)), etc. In this example, K-means is applied to cluster the item embeddings into a set of groups, with items within the same cluster deemed to be semantic neighbors.

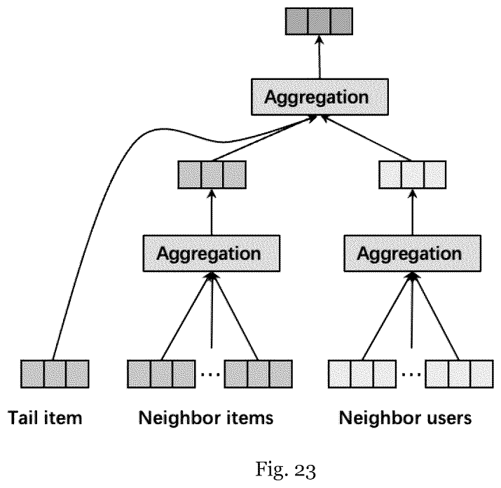

In some embodiments, message passing is performed. After graph construction and augmentation, neighborhood information is aggregated to reinforce self node representation. FIG. 23 illustrates a message passing operation in GALORE in some embodiments of the invention. Take the tail item i as an example. In this example, first denote the structural neighbors of item i as Nₒ^{str}(i) and semantic neighbors as Nₒ^{sma}(i). Then the homogeneous neighbors of item i are Nₒ(i)=Nₒ^{str}(i)∪Nₒ^{sma}(i). In this example, the heterogeneous neighbors of item i is defined as Nₑ(i). Similarly, Nₒ(u) is defined as homogeneous neighbors of user u and Nₑ(u) as heterogeneous neighbors of user u.

In one embodiment, to update the representation of the item node at the layer t(of the GNN), the GNN first aggregates the representations of its neighbors at the layer t−1, then combines them with its own representation. The process can be denoted as follows:

$${h}_{N ( i )}^{t} = AGGREGATE ( \{ {h}_{v}^{t - 1} , {∀}_{v} ∈ {N}_{o} ( i ) ⋃ {N}_{e} ( i ) \} ) \qquad ( 2 )$$

$${h}_{i}^{t} = COMBINE ( {h}_{i}^{t - 1} , {h}_{N ( i )}^{t} )$$

where h_{N(i)}^{t} is ID embedding of item node i at layer t, AGGREGATE( ) denotes neighbor aggregation function, such as averaging or maxpooling operation, and COMBINE( ) denotes the function that merges the aggregated neighborhood representation with the node's representation. An example is to use averaging operation. Another example is to use attention mechanism, which may be, e.g.:

$${h}_{{N}_{o} ( i )}^{t} = {\sum }_{p ∈ {N}_{o} ( i )} {α}_{i , p}^{t} {h}_{p}^{t - 1} \qquad ( 3 )$$

$${α}_{i , p}^{t} = \frac{exp ( L e a k y R e L U ( {a}_{i , t}^{T} [ {h}_{i}^{t - 1} ‖ {h}_{p}^{t - 1} ] ) )}{{Σ}_{k ∈ {N}_{o} ( i )} exp ( L e a k y R e L U ( {a}_{i , t}^{T} [ {h}_{i}^{t - 1} ‖ {h}_{k}^{t - 1} ] ) )}$$

where α_{i,p}^{t} is the normalized attention weight of homogeneous neighbor node p at layer t, a_{i,t} stands for each layer using its own attention parameters, the operator ∥ denotes concatenation, and LeakyReLU( ) denotes the activation function.

After obtaining T layers representations, a readout function can be used to generate the final representations for prediction:

$${h}_{i} = READOUT ( {h}_{i}^{t} \vert t = [ 0 , … , T ] ) \qquad ( 4 )$$

In one example, the weighted sum operation is used as the READOUT( ).

In some embodiments, a similar procedure is applied for the user nodes. However, as user nodes do not have homogeneous neighbor nodes, the process is described as:

$${h}_{N ( u )}^{t} = AGGREGATE ( \{ {h}_{v}^{t - 1} , {∀}_{v} ∈ {N}_{e} ( i ) ( u ) \} ) \qquad ( 5 )$$

$${h}_{u}^{t} = COMBINE ( {h}_{u}^{t - 1} , {h}_{N ( u )}^{t} )$$

$${h}_{u} = READOUT ( {h}_{u}^{t} \vert t = [ 0 , … , T ] )$$

In some embodiments of GALORE, edge dropping is applied.

Rong et al., DropEdge: Towards Deep Graph Convolutional Networks on Node Classification (2019), has demonstrated the efficacy of edge dropping in improving graph representation learning and mitigating over-smoothing issues. However, treating all edges equally may not be optimal in the context of long-tail recommendation scenarios. In long-tail recommendation settings, the tail item nodes typically have fewer connections than the head item nodes, making the edge connections for tail items more critical for achieving effective recommendation performance. Nevertheless, indiscriminate edge dropping for tail items may destroy the local graph structure and negatively impact the message-passing process, leading to degraded long-tail performance.

To address this issue, some embodiments apply adaptive heterogeneous edge dropping, which drops more edges for head items and fewer edges for tail items. In some embodiments, instead of using metrics like the node degree, which may not be discriminative enough, long-tail coefficient lᵢ is defined for item i to quantify how much a node is located in the tail of the distribution. Specifically, in one example, the long-tail coefficient is defined as follows:

$${l}_{i} = min ( {log ( deg ( i ) + 1 )}^{- 1} , {l}_{c} ) \qquad ( 6 )$$

where deg(i) is the degree of item node i, and l_{c} is a cutoff number. A larger long-tail coefficient value indicates that the item has fewer user feedback.

The edge between user u and item i is dropped with probability pᵤᵢ, which is calculated as

$${p}_{u i} = max ( \frac{{l}_{max} - {l}_{i}}{{l}_{max} - {l}_{min}} \cdot {p}_{e} , {p}_{c} ) \qquad ( 7 )$$

where lₘₐₓ and lₘᵢₙ are the maximum and minimum long-tail coefficients of the items, respectively, pₑ is a hyper-parameter that controls the overall probability of removing edges, and p_{c}<1 is a cut-off probability.

The edge dropping in these embodiments is tailored to address the specific challenges of long-tail recommendation scenarios by dropping more edges for head items and fewer edges for tail items, thereby enhancing the recommendation performance while preserving the local graph structure for tail items.

In some embodiments of GALORE, node synthesis is applied.

Inventors of the present invention have appreciated that synthetic minority oversampling, such as SMOTE (as disclosed in Chawla et al., SMOTE: synthetic minority over-sampling technique (2002)) and Embed-SMOTE (as disclosed in Ando et al., Deep over-sampling framework for classifying imbalanced data (2017)) is a model-agnostic technique for addressing the data imbalance problem, and the GraphSMOTE method (as disclosed in Zhao et al., GraphSMOTE: Imbalanced node classification on graphs with graph neural networks (2021)), extends the application to graph data. Inventors of the present invention have realized that directly applying GraphSMOTE to recommendation tasks may be sub-optimal because in recommender systems, the graph edges have special meaning as they represent user preferences towards items whereas the edge generator in GraphSMOTE generates edges based on model predictions, which can introduce noise and negatively impact model performance, particularly for tail nodes with inaccurate predictions.

To this end, in some embodiments, synthetic nodes after obtaining user/item representations through the GNN but before the optimization process. This is because adding synthetic nodes after obtaining the embeddings can negatively impact the connectivity of existing tail item nodes. To address the issue of GraphSMOTE, some embodiments utilize data mixup for node synthesis. In some examples, two items i and j are first chosen, e.g., randomly, then a synthetic item node i is generated based on the chosen items. The embedding of the synthetic item node ĩ is the convex combination of the embeddings eᵢ and eⱼ of item i and item j, i.e.,:

$${e}_{\tilde{ι}} = λ {e}_{i} + ( 1 - λ ) {e}_{j} \qquad ( 8 )$$

where λ∈[0,1] is a hyper-parameter. In one example, when λ>0.5, the synthetic item i is connected to the same users as item i; otherwise, the synthetic item ĩ has the same connections as item j. This may help to avoid the introduction of potential additional noise in GraphSMOTE. When λ=0 or 1, the mixing operation is equivalent to data resampling operation.

In some embodiments, the node synthesis involves hard negative mining. The basic idea of the hard negative mining is to focus more on examples that are hard to classify or rank correctly. In the context of recommender systems, hard negative mining can be used to identify negative samples that are difficult to distinguish from positive samples by the recommendation model. Therefore, these samples would require more attention from the model and thus could enhance the model performance.

In some embodiments, the synthetic nodes can serve as hard negative mining to boost the model performance. For example, suppose user u has interacted with item i and not with item j. Then item i is a positive sample, and item j is a negative sample. A synthetic node i can be generated by performing mixup on the embeddings of i and j. In this manner, it is more difficult to tell whether the synthetic node is positive or negative, compared to item i or j because it incorporates information from both items. As a result, the model must be more meticulous in differentiating this hard negative sample. This could in turn elevate the model's ability to distinguish positive samples from negative samples.

By using synthetic nodes as negative samples, examples that are challenging for the model to correctly classify can be identified. These synthetic nodes may contain information from both positive and negative samples, making them informative but fake negatives. By including these synthetic nodes in the training data, the model can be forced to better distinguish between positive and negative samples, which in turn lead to improved performance.

In some embodiments of GALORE, a two-stage training strategy is applied.

In some embodiments, the two-stage training strategy includes, in a first stage, following standard graph-based recommendation model training process, with the primary objective of facilitating the learning of high-quality representations for the head items, and in a second stage, employing graph augmentation (edge addition, edge drop, and/or node synthesis). Since the tail items are typically more challenging to learn, the tail portion of the graph is augmented to perform the second stage training of the model.

One advantage of this two-stage training strategy is that it allows the model to focus on different aspects of the representation learning problem during distinct training stages. Specifically, the model first gains proficiency in learning the head portion, which is comparatively easier to learn, before progressing to the more complex tail portion in the subsequent stage.

In some embodiments of GALORE, an optimization strategy is applied.

In some embodiments, after obtaining the user embedding and item embedding via GNN, the inner product (of the user and item embeddings) is obtained to estimate the user's preference towards the target item. Specifically, the model prediction for user u towards item i is denoted as:

$${\hat{y}}_{i} = {e}_{u}^{T} {e}_{i} \qquad ( 9 )$$

where eᵤ and eᵢ are the embeddings for user u and item i, respectively.

To encourage the prediction of observed user-item pairs to be higher than unobserved ones, some embodiments use the Bayesian Personalized Ranking (BPR) loss (as disclosed in Rendle et al., BPR: Bayesian personalized ranking from implicit feedback (2012)), which is defined as:

$${ℒ}_{b p r} = - {\sum }_{u = 1}^{M} {\sum }_{i ∈ {N}_{u}} {\sum }_{i ∉ {N}_{u}} ln σ ( {\hat{y}}_{{u}_{i}} - {\hat{y}}_{{u}_{j}} ) \qquad ( 10 )$$

where Nᵤ is the set of observed interacted items with user u, and σ is the sigmoid function.

In some embodiments, the overall loss is the sum of the recommendation loss and the regularization loss, defined as:

$${ℒ}_{o v e r a l l} = {ℒ}_{b p r} + γ {‖ Θ ‖}_{2}^{2} \qquad ( 11 )$$

where Θ is the vector of the model parameters, γ is a hyper-parameter that controls the strength of the L2 regularization loss. In some embodiments, the Adam optimizer (as disclosed in Kingma et al., Adam: A method for stochastic optimization (2014)) is applied to optimize the loss function to minimize the loss.

To evaluate the performance and analyze various components of the GALORE in some embodiments, experiments are performed on four real-world datasets from different domains. Specifically, experiments are performed to determine how GALORE performs compared with existing baseline methods with respect to all items and tail items, to determine how the incorporation of graph augmentation and training strategy in GALORE may affect the recommendation performance, and to determine how the hyper-parameters may affect the GALORE performance.

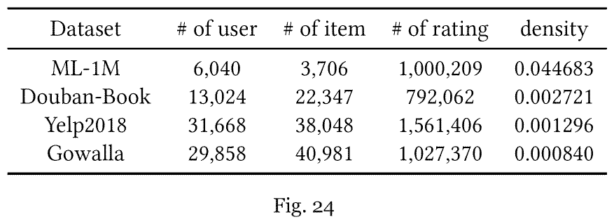

In this example, the experiments are conducted on four publicly-available real-world datasets, details of which is shown in FIG. 24:
(1) MovieLens (https://grouplens.org/datasets/movielens/)
   MovieLens is a movie rating dataset that is used for evaluating recommendation algorithms. In this example, MovieLens-1M (ML-1M), which includes around 1,000,000 user ratings, is used.
(2) Douban-book (https://github.com/librahu/HIN-Datasets-for-Recommendation-and-Network-Embedding)
   Douban-book contains users' ratings of books.
(3) Yelp2018 (https://www.yelp.com/dataset/challenge)
   Yelp2018 is from the Yelp-2018 challenge and it relates to the task of recommending business webpages to users.
(4) Gowalla (as referred to in He et al., LightGCN: Simplifying and powering graph convolution network for recommendation (2020))
   Gowalla is a dataset that contains check-in information from users who share their locations.

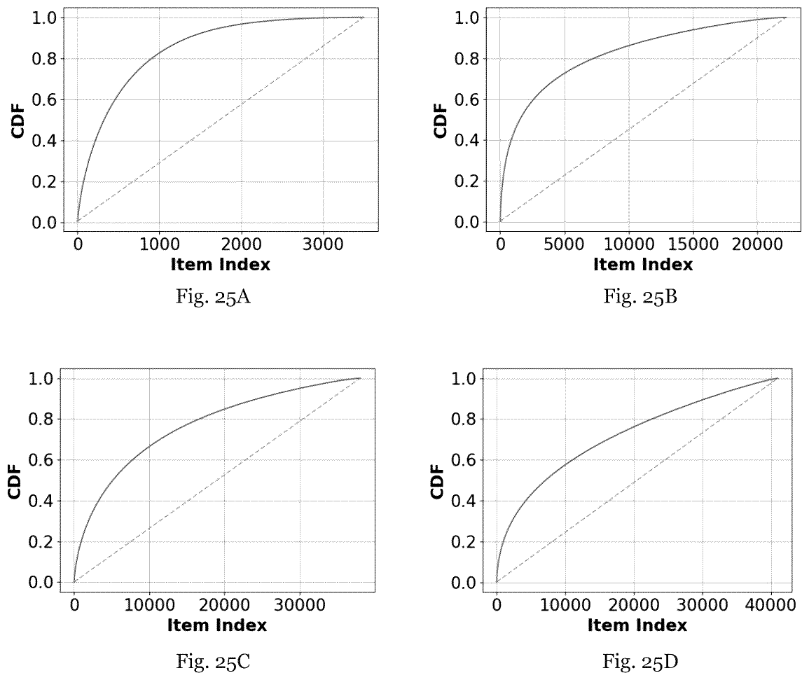

FIGS. 25A to 25D show the item distribution in all of the four datasets (FIG. 25A, ML-1M dataset; FIG. 25B, Douban-Book dataset; FIG. 25C, Yelp2018 dataset; FIG. 25D, Gowalla dataset). It can be observed from FIGS. 25A to 25D that the item distribution in all of the four datasets exhibits a highly-skewed, long-tail pattern. This characteristic makes these datasets particularly suitable for the experiments to address the challenge of improving recommendation quality for the long-tail distribution.

In the experiments, the GALORE in some embodiments is compared with existing model-agnostic baseline methods (including data reweighting, loss function refinement, meta learning, and graph augmentation learning methods). To ensure a fair comparison, LightGCN is used as the backbone model for all methods. The same layers and embedding dimensions are adopted across all methods. Specifically, the baseline methods used in the experiments are as follows:
(1) Backbone model:
   LightGCN (as disclosed in He et al., LightGCN: Simplifying and powering graph convolution network for recommendation (2020)): A lightweight model which simplifies the weight parameter aggregation steps in graph convolution network.
(2) Resampling Strategies (as disclosed in Brownlee, Imbalanced classification with Python: better metrics, balance skewed classes, cost-sensitive learning (2020)):
   Over-sampling: sample more from tail items to re-balance the head items and tail items in the training data distribution.
   Under-sampling: keep the tail items unchanged and down-sample the head items in contrast to over-sampling.
(3) Loss function refinement methods:
   Focal Loss (FL) (as disclosed in Lin et al., Focal loss for dense object detection (2017)): reweights the standard loss to assign less weight for well-classified examples.
   ClassBalance (as disclosed in Cui et al., Class-balanced loss based on effective number of samples (2019)): calculates the effective number of samples to reweight loss for each class.
(4) Meta-learning model:
   MeLu (as disclosed in Lee et al., MeLU: Meta-learned user preference estimator for cold-start recommendation (2019)): applies optimization-based meta-learning (MAML) for cold-start item rating prediction.
(5) Graph augmentation learning methods:
   DropEdge (as disclosed in Rong et al., DropEdge: Towards Deep Graph Convolutional Networks on Node Classification (2019)): randomly removes graph edges in the message passing mechanism to alleviate over-smoothing.
   GraphSMOTE (as disclosed in Zhou et al., GraphSMOTE: Imbalanced node classification on graphs with graph neural networks (2021)): an oversampling technique using graph based synthetic minority oversampling to address class imbalance in graph-structured data.

Various settings are applied in the experiments in this example. In this example, the experiment setting disclosed in Yu et al., Graph Augmentation Learning (2022) is followed to discard ratings less than 4 in Movielens and Douban-book dataset, which is with a 1-5 rating scale, and reset the rest to 1. The datasets are split into three parts (training set, validation set, and test set) with a ratio of 7:1:2. Pareto principle (as disclosed in Box et al., An analysis for unreplicated fractional factorials (1986)) is used as the criteria to split the head and tail items. The top ranked 20% number of occurrence of items are set as head items and the rest are set as tail items. The metrics evaluated on the tail and head item sets are reported respectively. The average performance by five runs is reported.

One of the settings relates to evaluation metrics. In this example, two evaluation metrics are employed to evaluate the performance: (1) Recall, which measures the chance that the recommendation list contains users' interested items, and (2) Normalized Discounted Cumulative Gain (NDCG), which puts more weight on items that are ranked higher in the recommendation list. In this example, Recall@K (or simply R@K) and NDCG@K (or simply N@K), with K E {20,50}, are evaluated.

One of the settings relates to hyperparameters. In this example, to obtain a fair comparison, the best hyper-parameter settings reported in the publications associated with the baseline methods are referenced and all the hyperparameters of the baseline methods are fine-tuned with grid search. For the general settings of all the baseline methods, Xavier initialization (as disclosed in Glorot et al., Understanding the difficulty of training deep feedforward neural networks (2010)) is used on all the embeddings. In this example, the embedding size is 64, the parameter for L₂ regularization is 10-4 and the batch size is 2048. The Adam optimizer with a learning rate of 0.001 is used to optimize all the models. For GALR, the structural neighbor number is chosen from {3, 5, 10} and the cluster number is chosen from {3, 5, 10, 20}. In the experiments, for GALORE, the structural neighbor number is chosen from {1, 3, 5,10}, the overall edge drop rate is selected from {0.1, 0.3, 0.5}, and A is selected from the range of {0.8, 0.9, 1.0}.

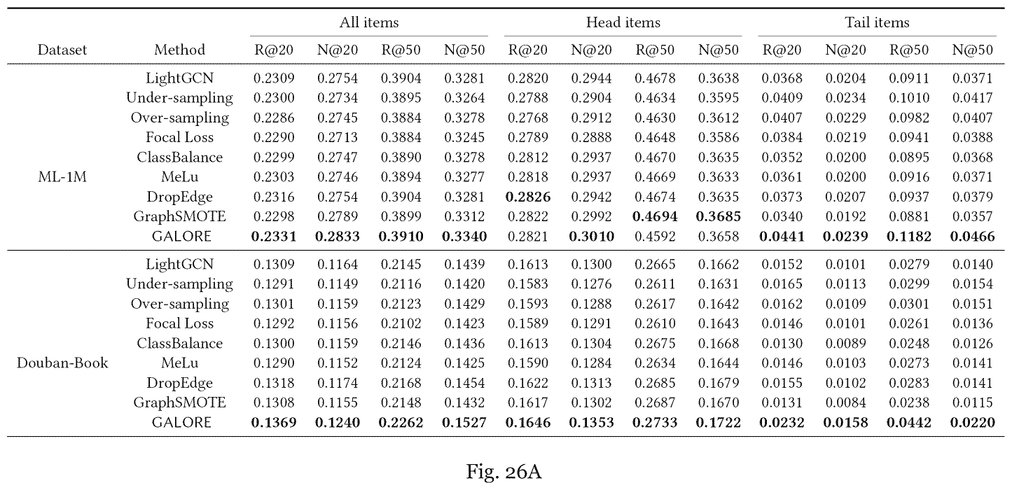

The performance of the baseline methods and the GALORE in some embodiments are evaluated using the four datasets to explore the models' performance under different scenarios. FIGS. 26A and 26B contain tables that summarize the recommendation performance of all items, head items, and tail items on these datasets.

Several observations can be made based on the obtained recommendation performance First, the GALORE embodiment outperforms the LightGCN model by a significant margin, demonstrating its effectiveness in enhancing both tail and head item recommendation. This underscores the importance of considering graph augmentation within longtail item distributions. The results also show that the training strategy in GALORE can improve recommendation performance for long-tail distribution data.

Second, the GALORE embodiment outperforms the reweighting methods, including under-sampling and over-sampling, across all three splits in almost all cases. Notably, over-sampling performs slightly worse than under-sampling on the tail item splits. However, the re-sampling method may change the original data distribution and thus negatively affect the overall model performance. Furthermore, the experiments show that meta-learning and refining loss function strategies fail to achieve superior performance on head and tail items. This suggests that meta-learning methods may struggle with no model parameters and user/item features. For refining loss function strategies, their tradeoff between head and tail items may prove detrimental to the overall performance.

Third, the GALORE embodiment outperforms, hence is superior compared to, graph augmentation models such as DropEdge and GraphSMOTE in most cases. These findings demonstrate the efficacy of the tailored adaptive graph augmentation in the GALORE embodiment in improving long-tail recommendation performance. Moreover the two-stage training approach in the GALORE embodiment may enhance the learning representation by assigning different learning objectives to each stage.

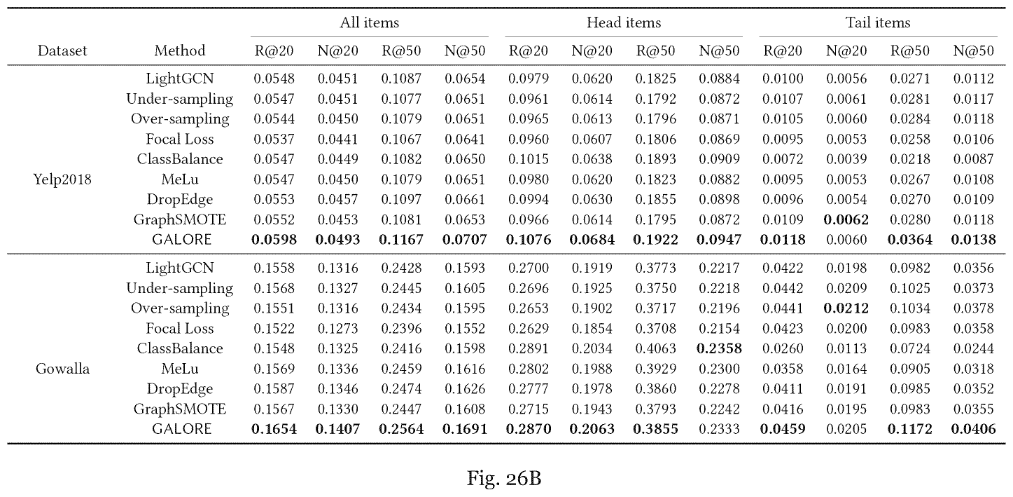

Ablation studies are also performed to analyze different components of the GALORE embodiment. FIG. 27 shows the results of the ablation studies. The full GALORE embodiment outperforms all GALORE variants on three splits, which indicates that all main components in this GALORE embodiment can be used to contribute to performance improvement.

The four GALORE variants and their results are as follows.

One of the GALORE variants is without edge addition. In this variant, adaptive edge addition is not used while the other components/operations remain unchanged. The performance of the model without adaptive edge addition significantly degrades on tail items, indicating that the head items could pass useful information to their neighboring tail items through adaptive edge addition, as hypothesized.

One of the GALORE variants is without edge dropping. In this variant, adaptive edge dropping is replaced with random uniform edge dropping while the other components/operations remain unchanged. The model's performance without adaptive edge dropping is relatively poor on tail items. This illustrates that adaptive edge dropping is useful for improving tail item recommendation since it retains critical graph structure information for tail items.

One of the GALORE variants is without synthetic node. In this variant, node synthetic is not used while the other components/operations remain unchanged. The model's performance significantly degrades on the tail part, underscoring the effectiveness of synthetic nodes in mitigating data imbalance problems. Without synthetic nodes, the model tends to over-fit to the head part, resulting in poor performance and unfairness for the tail part of the data.

One of the GALORE variants is without two-stage training. In this variant, the first training stage is removed and only the second training stage (which trains the model on an augmented graph) is used. The results shows a severe degradation in head item performance, indicating the usefulness of two-stage learning. With two-stage learning, the model can learn different parts of the graph in each stage, thereby preventing overfitting on the tail part, which is difficult to learn.

These ablation studies show that all the main components of the GALORE embodiment can contribute to its performance. The edge addition, edge dropping, synthetic nodes, and two-stage learning are all useful for improving the recommendation performance, particularly for tail items.

Hyper-parameter studies are also performed.

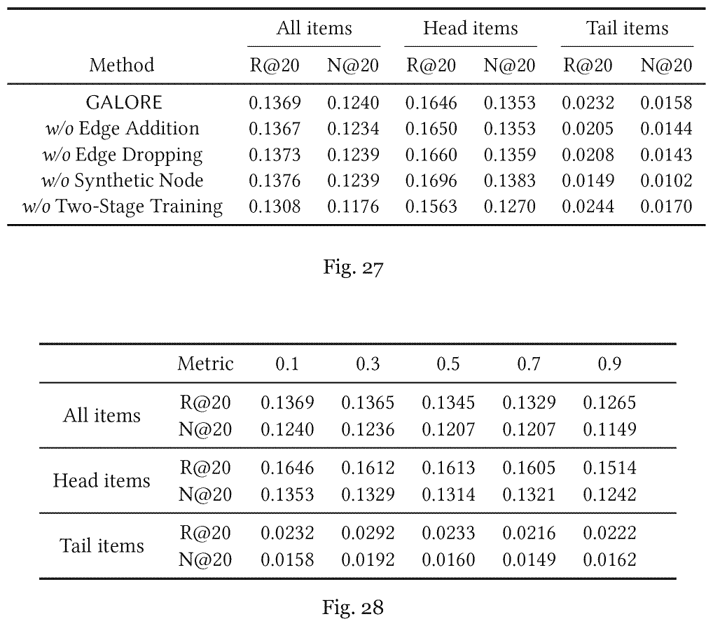

One of the hyper-parameter studies relates to the impact of edge drop rate. FIG. 28 shows a clear relationship between the total edge drop rate and the model performance across all three splits. Specifically, it is found that as the edge drop rate increases, the overall model performance decreases. For instance, when the edge drop rate is set to 0.9, the resulting graph structure is highly disrupted. In such cases, it becomes challenging for the graph neural network to derive meaningful information and optimize the model effectively. Moreover, an interesting trend in the tail performance can be observed, which first increases and then decreases as the edge drop rate increases. This can be attributed to the fact that dropping edges for head item nodes can improve the graph connectivity of tail item nodes, facilitating graph message passing and representation learning. This finding suggest that the edge drop rate is a useful parameter to consider when training graph-based models, as it can impact their performance. A careful selection of the edge drop rate can help to balance the trade-off between preserving graph connectivity and promoting effective representation learning.

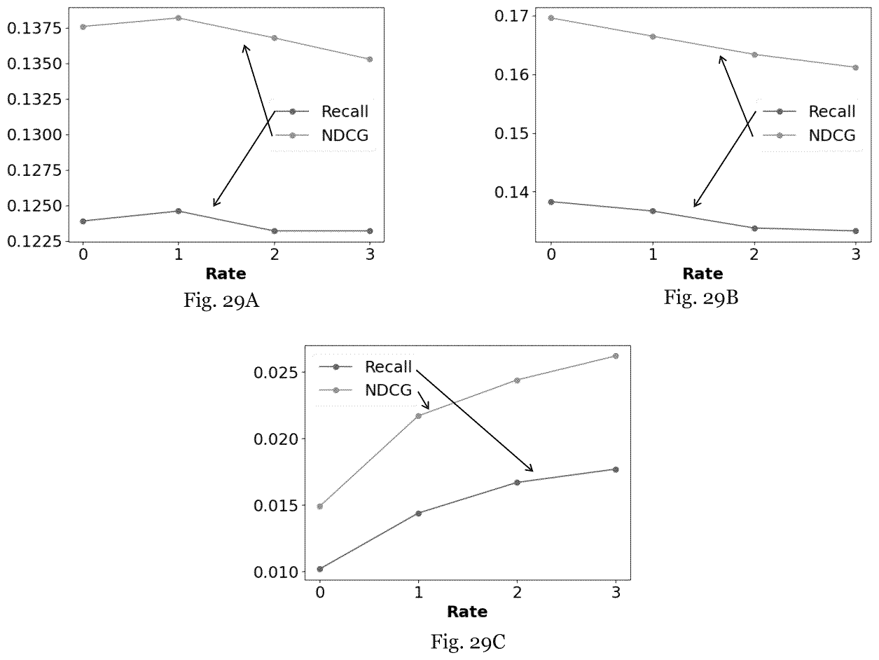

One of the hyper-parameter studies relates to the impact of synthetic node rate. This study is performed on the Douban-Book dataset. FIGS. 29A to 29C present the results of the experiments investigating the impact of synthetic node rates on model performance (FIG. 29A, all items, FIG. 29B, head items, FIG. 29C, tail items). The synthetic node rate represents the proportion of synthetic tail nodes to real tail nodes, with higher rates indicating the generation of more synthetic nodes. This study reveals the trend in the overall performance (all items, FIG. 29A), which first increases and then decreases as the synthetic node rate increases. In contrast, the tail performance (tail items, FIG. 29C) exhibits a consistent increase as the synthetic node rate increases whereas the head performance (head items, FIG. 29B) shows the opposite trend. This observation is consistent with expectations, as the generation of more synthetic nodes can generally alleviate the data imbalance problem in the graph and improve the long-tail performance. Specifically, the increased number of synthetic nodes can help to provide more training instances for tail items, which are often underrepresented in the data. By facilitating more effective representation learning for such items, the synthetic nodes can contribute to improving the tail performance of the model.

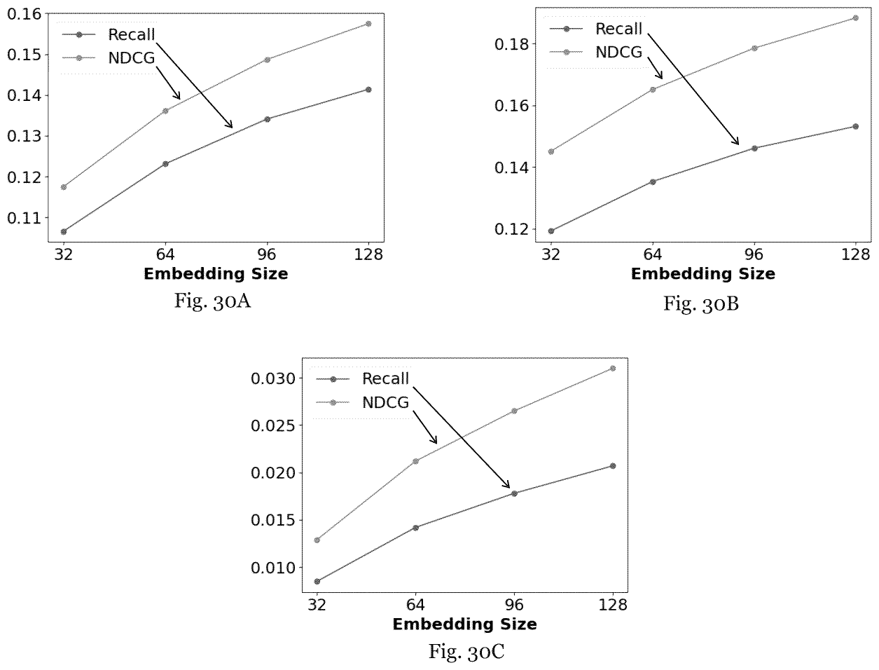

One of the hyper-parameter studies relates to the impact of embedding size. This study investigates the impact of embedding size, as a hyper-parameter, on model performance across three splits. FIGS. 30A to 30C present the results of the experiments investigating the impact of embedding size on model performance (FIG. 30A, all items, FIG. 30B, head items, FIG. 30C, tail items). It can be seen that the model performance increases consistently with the increase in embedding size across all three splits. One possible explanation for this observation is that larger embedding sizes can capture more complex patterns and richer semantic information, leading to enhanced expressiveness and improved performance. A significant improvement in performance is observed when the embedding size increases from 32 to 64. Notwithstanding, it should be noted that increasing the embedding size comes at a cost of higher computational resources, which may not always be feasible or desirable in practice. Thus, choosing an appropriate embedding size that balances the trade-off between model performance and computational cost can be useful.

While the GALORE embodiment described above focuses mainly on addressing the long-tail distribution from the item perspective, it should be appreciated that in other embodiments, GALORE can be adapted for long-tail user recommendations with suitable modifications. For example, homogeneous user-user edges can be added and/or user nodes can be synthesized to facilitate long-tail user recommendations. Integrating these modifications could enable long-tail recommendation for both the users and the items, thus enhancing the overall recommendation performance.

The GALORE in some embodiments is a plug-and-play and model-agnostic framework, hence can adapt a more powerful graph-based backbone model (e.g., SGL (as disclosed in Wu et al., Self-supervised graph learning for recommendation (2021)), SimGCL (as disclosed in Yu et al., Are graph augmentations necessary? simple graph contrastive learning for recommendation (2022)) to achieve better performance.

The above embodiments provide some example implementation of a long-tail recommendation model GALORE (i.e., Graph Augmentation for Long-tail Recommendation) for improving recommendation performance on tail items. In some embodiments, edge addition and adaptive edge dropping are applied, which improve the graph connectivity of tail items and enhance the representation learning process. In some embodiments, node synthesizing is applied to modify the data distribution and enable the model to focus more on the tail part. In some embodiments, to further improve the model's performance, a two-stage training scheme is applied to supervise the model learning process and prevent overfitting to the tail part. This approach allows the model to learn better representations in different stages, leading to improved performance on both head and tail items. The experiments performed on several benchmark datasets demonstrate the effectiveness of GALORE.

As mentioned, long-tail distribution of inherent user behaviors results in unsatisfactory recommendation performance for the items with fewer user records (i.e., tail items) than those with more user records (i.e., head items). Existing techniques for alleviating the long-tail recommendation problem mainly focus on traditional methods, and there lacks graph-based methods that can be applied to efficiently deal with the long-tail recommendation problem. In some embodiments of the invention, a Graph Augmentation framework for Long-tail Recommendation (GALORE), which can be plugged into (applied in or with) various graph-based recommendation models to improve the performance for tail items, is proposed. In some embodiments, GALORE may include various features: edge addition that enriches the connectivity of the graph for tail items by injecting additional item-to-item edges; a degree-aware edge dropping which preserves the more valuable edges from the tail items while selectively discards less informative edges from the head items; new data samples are synthesized to address the data scarcity issue for tail items; a two-stage training strategy is applied to facilitate the learning for both head and tail items; etc.

### Example System

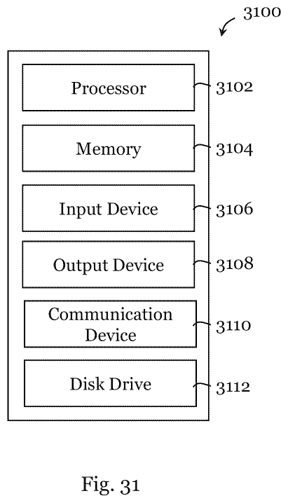

FIG. 31 shows an example data processing system 3100 in some embodiments of the invention. The data processing system 3100 can be used to implement one or more of the operations, methods, models, frameworks, etc., of the invention, at least partly or entirely. For example, the data processing system 3100 can be used to implement any of the operations, methods, models, frameworks, etc., described with reference to the Figures. The data processing system 3100 generally comprises suitable components necessary to receive, store, and execute appropriate computer instructions, commands, and/or codes. The main components of the data processing system 3100 are a processor 3102 and a memory (storage) 3104. The processor 3102 may include one or more: CPU(s), MCU(s), GPU(s), logic circuit(s), Raspberry Pi chip(s), digital signal processor(s) (DSP), application-specific integrated circuit(s) (ASIC), field-programmable gate array(s) (FPGA), or any other digital or analog circuitry/circuitries configured to interpret and/or to execute program instructions and/or to process signals and/or information and/or data. The processor 3102 may be used to train and/or operate the GNN based recommender model(s) and system in some embodiments. The processor 3102 may be used to perform any one or more of the method embodiments of the invention, in part or entirely. The memory 3104 may include one or more volatile memory (such as RAM, DRAM, SRAM, etc.), one or more non-volatile memory (such as ROM, PROM, EPROM, EEPROM, FRAM, MRAM, FLASH, SSD, NAND, NVDIMM, etc.), or any of their combinations. Appropriate computer instructions, commands, codes, information and/or data may be stored in the memory 3104. For example, the memory 3104 may store the training/testing/validation data for the GNN based recommender model(s) and system. For example, the memory 3104 may store the original or trained GNN based recommender model(s) and system. Computer instructions for executing or facilitating executing the method embodiments of the invention may be stored in the memory 3104. For example, the memory 3104 may store program instructions or codes for performing any one or more of the method embodiments of the invention, in part or entirely. The processor 3102 and memory (storage) 3104 may be integrated or separated (and operably connected). In some embodiments, the data processing system 3100 further includes one or more input devices 3106. Example of such input device 3106 include: keyboard, mouse, stylus, image scanner, microphone, tactile/touch input device (e.g., touch sensitive screen), image/video input device (e.g., camera), etc. In some embodiments, the data processing system 3100 further includes one or more output devices 3108. Example of such output device 3108 include: display (e.g., monitor, screen, projector, etc.), speaker, headphone, earphone, printer, additive manufacturing machine (e.g., 3D printer), etc. The display may include a LCD display, a LED/OLED display, or other suitable display, which may or may not be touch sensitive. The training and/or operation results of the GNN based recommender model(s) and system may be displayed by the display. The data processing system 3100 may further include one or more disk drives 3112 which may include one or more of: solid state drive, hard disk drive, optical drive, flash drive, magnetic tape drive, etc. A suitable operating system may be installed in the data processing system 3100, e.g., on the disk drive 3112 or in the memory 3104. The memory 3104 and the disk drive 3112 may be operated by the processor 3102. In some embodiments, the data processing system 3100 also includes a communication device 3110 for establishing one or more communication links (not shown) with one or more other computing devices, such as servers, personal computers, terminals, tablets, phones, watches, IoT devices, or other wireless computing devices. The communication device 3110 may include one or more of: a modem, a Network Interface Card (NIC), an integrated network interface, a NFC transceiver, a ZigBee transceiver, a Wi-Fi transceiver, a Bluetooth® transceiver, a radio frequency transceiver, a cellular (2G, 3G, 4G, 5G, above 5G, or the like) transceiver, an optical port, an infrared port, a USB connection, or other wired or wireless communication interfaces. Transceiver may be implemented by one or more devices (integrated transmitter(s) and receiver(s), separate transmitter(s) and receiver(s), etc.). The communication link(s) may be wired or wireless for communicating commands, instructions, information and/or data. In one example, the processor 3102, the memory 3104 (In some embodiments the input device(s) 3106, the output device(s) 3108, the communication device(s) 3110 and the disk drive(s) 3112, if present) are connected with each other, directly or indirectly, through a bus, a Peripheral Component Interconnect (PCI), such as PCI Express, a Universal Serial Bus (USB), an optical bus, or other like bus structure. In some embodiments, at least some of these components may be connected wirelessly, e.g., through a network, such as the Internet or a cloud computing network. A person skilled in the art would appreciate that the data processing system 3100 shown in FIG. 31 is merely an example and that the data processing system 3100 can in other embodiments have different configurations (e.g., include additional components, has fewer components, include alternative components, etc.).

Although not required, the embodiments described with reference to the Figures can be implemented as an application programming interface (API) or as a series of libraries for use by a developer or can be included within another software application, such as a terminal or computer operating system or a portable computing device operating system. Generally, as program modules include routines, programs, objects, components and data files assisting in the performance of particular functions, the skilled person will understand that the functionality of the software application may be distributed across a number of routines, objects and/or components to achieve the same functionality desired herein.

It will also be appreciated that where the methods and systems of the invention are either wholly implemented by computing system or partly implemented by computing systems then any appropriate computing system architecture may be utilized. This will include stand-alone computers, network computers, dedicated or non-dedicated hardware devices. Where the terms “computing system” and “computing device” are used, these terms are intended to include (but not limited to) any appropriate arrangement of computer or information processing hardware capable of implementing the function described.

Embodiments of the invention provide various features.

For example, some embodiments have provided an adaptive augmentation framework for addressing the long-tail recommendation problem with edge addition and graph topology augmentation. For example, some embodiments utilize training data augmentation to force the GNN based model(s) to learn more about the tail part. For example, in some embodiments, instead of picking low degree nodes to augment, nodes are selected based on performance improvement through a bilateral branch network.

For example, some embodiments have provided a graph augmentation framework for addressing the long-tail recommendation problem through graph augmentation, which includes edge addition and edge dropping. The graph augmentation may improve graph connectivity of tail items and may facilitate learning of better representation for tail items. For example, some embodiments utilize a node synthesis technique to alleviate the data imbalance problem and allow the model to learn from more data on the tail items. For example, some embodiments utilize a two-stage training strategy that enables the model to learn representations of head items and tail items at different stages.

Embodiments of the invention provide various functions. For example, some embodiments improve the recommendation performance for tail items in a long-tail distribution of user behaviors. For example, in some embodiments, the proposed frameworks can achieve recommendation performance improvement by using adaptive edge dropping and addition, introducing higher-order homogeneous information for tail items, and incorporating contrastive learning to enhance representation learning.

Embodiments of the invention could be applied in various recommendation systems/applications, such as e-commerce, online streaming, social media, and personalized content delivery. These systems may encounter the long-tail distribution of user behaviors, where many tail items have few user records and can be challenging to recommend accurately. By improving the recommendation performance for tail items, the invention could enhance the overall user experience of these systems. In some embodiments of the invention, the “item” may include, e.g., digital image, photograph, electronic document or file, web page, part of a web page, map, electronic link, commercial product, non-commercial product, multimedia file, song, book, album, article, database record, human, object etc.

Embodiments of the invention provide various advantages. For example, some embodiments improve performance on tail items. Some embodiments of the invention provide a more effective, efficient, and/or practical solution for improving the recommendation performance for tail items in a long-tail distribution of user behaviors.

It will be appreciated by a person skilled in the art that variations and/or modifications may be made to the described and/or illustrated embodiments of the invention to provide other embodiments of the invention. The described/or illustrated embodiments of the invention should therefore be considered in all respects as illustrative, not restrictive. Example optional features of some embodiments of the invention are provided in the summary and the description. Some embodiments of the invention may include one or more of these optional features (some of which are not specifically illustrated in the drawings). Some embodiments of the invention may lack one or more of these optional features (some of which are not specifically illustrated in the drawings). For example, the neural network based ranking model of the invention can have different network architecture, i.e., not limited to those specifically described or illustrated.

1. A computer-implemented method for training a graph neural network based recommendation system, comprising:
receiving a dataset comprising user data associated with users, item data associated with items, and user-item interaction data associated with user-item interactions, with some of the items having less user-item interactions than some other of the items;
processing the dataset to generate graph representation data of the dataset, the graph representation data comprising data associated with nodes and data associated with edges connecting the nodes, the nodes comprising user nodes corresponding to the users and item nodes corresponding to the items, the edges comprising user-item interaction edges corresponding to the user-item interactions, each user-item interaction edge being connected with an item node and a user node, with some of the item nodes having less user-item interaction edges than some other of the item nodes;
processing the graph representation data of the dataset to modify the graph representation data of the dataset and obtain modified graph representation data of the dataset, which can facilitate learning or determining of representations of at least some of the item nodes with less user-item interactions; and
training one or more graph neural network based recommender models of the graph neural network based recommendation system based at least in part on the modified graph representation data.

2. The computer-implemented method of claim 1, wherein an amount of the user-item interactions in respect of the items generally follows a heavy-tail or long-tail distribution.

3. The computer-implemented method of claim 1, wherein processing the graph representation data of the dataset comprises:
performing an edge addition operation to add one or more edges to the graph representation data.

4. The computer-implemented method of claim 3, wherein performing the edge addition operation comprises:
performing a homogenous edge addition operation to add, to the graph representation data, one or more item-item edges for at least some of the item nodes with less user-item interaction edges, wherein each of the one or more item-item edges is respectively connected with two item nodes, at least one of which is one of the item nodes with less user-item interaction edges.

5. The computer-implemented method of claim 4, wherein performing the homogenous edge addition operation comprises:
for each of the at least some of the item nodes with less user-item interactions, respectively:
determining, from the item nodes, one or more structural neighbor item nodes; and
adding, to the graph representation data, one or more item-item edges each between the corresponding item node and one of its one or more structural neighbor item nodes.

6. The computer-implemented method of claim 5, wherein determining one or more structural neighbor item nodes comprises:
determining an item similarity matrix based on the user-item interactions, the item similarity matrix comprising co-interaction values each for two respective items; and
determining the one or more structural neighbor item nodes based on the co-interaction values in the item similarity matrix.

7. The computer-implemented method of claim 4, wherein performing the homogenous edge addition operation comprises:
for each of the at least some of the item nodes with less user-item interactions, respectively:
determining, from the item nodes, one or more sematic neighbor item nodes; and
adding, to the graph representation data, one or more item-item edges each between the corresponding item node and one of its one or more sematic neighbor item nodes.

8. The computer-implemented method of claim 7, wherein determining one or more sematic neighbor item nodes comprises:
clustering the items based on a clustering method to form a plurality of clusters of items; and
adding one or more item-item edges each between the corresponding item node and one of the items in the same cluster as the corresponding item node.

9. The computer-implemented method of claim 8, wherein the clustering is based on K-means method or a mean-shift method.

10. The computer-implemented method of claim 8, wherein performing the homogenous edge addition operation comprises:
performing a message passing operation based at least in part on the graph representation data added with the one or more item-item edges each between the corresponding item node and one of its one or more structural neighbor item nodes and the one or more item-item edges each between the corresponding item node and one of its one or more sematic neighbor item nodes.

11. The computer-implemented method of claim 3, wherein processing the graph representation data of the dataset further comprises:
performing an edge drop operation to drop one or more of the user-item interaction edges.

12. The computer-implemented method of claim 11, wherein performing the edge drop operation comprises:
performing an adaptive heterogeneous edge drop operation to drop some of the user-item interaction edges in such a way that an amount of user-item interaction edges dropped in respect of at least some of the item nodes with less user-item interactions is less than an amount of user-item interaction edges dropped in respect of item nodes with more user-item interactions.

13. The computer-implemented method of claim 12, wherein performing the adaptive heterogeneous edge drop operation comprises:
for each of at least some of the item nodes, respectively:
determining an extent of which an item node has insufficient user interactions; and
dropping user-item interaction edges associated with the item node based on the determined extent such that more user-item interaction edges are dropped for item nodes with less insufficient user interactions and less user-item interaction edges are dropped for item nodes with more insufficient user interactions.

14. The computer-implemented method of claim 11, wherein processing the graph representation data of the dataset further comprises:
performing a node synthesis operation to add one or more synthetic item nodes and one or more corresponding synthetic user-item interaction edges to the graph representation data.

15. The computer-implemented method of claim 14, wherein performing the node synthesis operation comprises:
processing the graph representation data of the dataset using the one or more graph neural network based recommender models of the graph neural network based recommendation system to determine embeddings associated with the user nodes and embeddings associated with the item nodes;
performing a data mixup operation to generate one or more synthetic item nodes based at least in part on the embeddings associated with the user nodes and the embeddings associated with the item nodes; and
for each of the one or more synthetic item nodes, generating a corresponding synthetic user-item interaction edge based at least in part on a hyper-parameter.

16. The computer-implemented method of claim 14, wherein performing the node synthesis operation comprises:
processing the graph representation data of the dataset using the one or more graph neural network based recommender models of the graph neural network based recommendation system to determine a set of data including user-item-interaction triplets and corresponding embeddings associated with the graph representation data;
performing a first data augmentation operation on the set of data to generate a first synthesized dataset with one or more synthesized user-item-interaction triplets and one or more corresponding synthesized embeddings;
processing the set of data and the first synthesized dataset using a bilateral branch network model to compare or determine performance of the item nodes;
based on the comparison or determination, selecting item nodes for performing data augmentation; and
performing a second data augmentation operation on the set of data for the selected item nodes to generate a second synthesized dataset including the one or more synthetic item nodes and the one or more corresponding synthetic user-item interaction edges.

17. The computer-implemented method of claim 16,
wherein the bilateral branch network model comprises two generally identical branches each including one or more graph neural network based recommender models; and
wherein the processing of the set of data and the first synthesized dataset comprises:
processing the set of data using one of the branches of the bilateral branch network model; and
processing a combination of the set of data and the first synthesized dataset using another one of the branches of the bilateral branch network model.

18. The computer-implemented method of claim 16,
wherein the first data augmentation operation comprises a data mixup operation and/or a data resampling operation;
wherein the second data augmentation operation comprises a data mixup operation and/or a data resampling operation;
wherein the data mixup operation comprising mixing one or more pairs of user-item-interaction triplets and their corresponding embeddings to generate synthesized data; and
wherein the data resampling operation comprises selectively drawing and dropping out at least some of the user-item-interaction triplets and corresponding embeddings from the set of data.

19. The computer-implemented method of claim 1, wherein the training comprises:
training the one or more graph neural network based recommender models of the graph neural network based recommendation system using graph contrastive learning technique.

20. The computer-implemented method of claim 19, wherein the training comprises optimizing a loss function that considers recommendation loss, regularization loss, and contrastive loss.

21. The computer-implemented method of claim 1, wherein the training comprises:
in a first training stage, training the one or more graph neural network based recommender models of the graph neural network based recommendation system using the graph representation data; and
in a second training stage, training the one or more one or more graph neural network based recommender models of the graph neural network based recommendation system using the modified graph representation data.

22. The computer-implemented method of claim 21, wherein the training comprises optimizing a loss function that considers, at least, recommendation loss and regularization loss.

23. A system for training a graph neural network based recommendation system, comprising:
one or more processors; and
memory storing one or more programs configured to be executed by the one or more processors, the one or more programs including instructions for performing or facilitating performing of to the computer-implemented method of claim 1.

24. A computer-implemented method for operating a graph neural network based recommendation system, comprising:
processing user data and item data, using the one or more graph neural network based recommender models of the graph neural network based recommendation system trained using the computer-implemented method of claim 1, to determine an item recommendation for a user.

25. A system for operating a graph neural network based recommendation system, comprising:
one or more processors; and
memory storing one or more programs configured to be executed by the one or more processors, the one or more programs including instructions for performing or facilitating performing of to the computer-implemented method of claim 24.
